(19) United States
(12) Patent Application Publication
(10) Pub. No.: US 2020/0408425 A1
(43) Pub. Date: Dec. 31, 2020

(54) Cooling, heating and humidity Stabilization Using Humidity Fluctuations

(71) Applicant: TERMOTERA LTD., Moshav Amirim (IL)

(72) Inventor: Dror Zchori, Tel Aviv (IL)

(73) Assignee: TERMOTERA LTD, Tel Aviv (IL)

(21) Appl. No.: 16/975,249

(22) PCT Filed: Feb. 26, 2019
(86) PCT No.: PCT/IL2019/050214

§ 371 Date: Aug. 24, 2020

Related U.S. Application Data
(60) Provisional application No. 62/635,263, filed on Feb. 26, 2018.

(51) Int. Cl. F24F 3/14; F24F 5/00

(52) U.S. Cl. CPC F24F 3/1417; B01D 53/263; F24F 5/0035

(57) ABSTRACT

The device and method of the invention are adapted to control temperature and humidity of the air in some defined volume such as a room in a house. The device consists of a quantity of hygroscopic material and means for passing air past or through the material. Direct temperature and humidity control occur when air is conditioned (heated and dried by sorption heating, or cooled and humidified by absorption cooling) and sent inside the room; indirect control is also possible, by affecting the temperature of the walls (the sorption material may occupy channels or spaces within the walls, which are then heated/cooled, indirectly heating/cooling the air in the room by conduction). A fan or blower will allow for forced convection of air in a desired path (e.g from outside the house, over/through the sorption material, and into the house, or in the opposite direction). A second fan and valves allow for more complex operations.

This application is a continuation of U.S. application 62/635,263 “Cooling, heating and humidity Stabilization Using Humidity Fluctuations” filed 26 Feb. 2018.

### 1. FIELD OF THE INVENTION

The present invention relates to the field of temperature and humidity control.

### 2. BACKGROUND OF THE INVENTION

When water evaporates from a material it absorbs both latent energy and binding energy, cooling the surroundings, and when a material absorbs water it releases this energy, heating the surroundings.

The purpose of this invention is to harness and store humidity conditions to power cooling, heating and humidity balancing by using the well known mechanisms of evaporative cooling and absorption/adsorption heating.

### 3. SUMMARY

The chemical potential of water adsorbed (or absorbed) in a hygroscopic material is the change in molar Gibbs free energy per molecule of water, mu=dU/dN. Water also has a chemical potential in air. When a hygroscopic material is dry and the air is moist, the chemical potential for water to be in the material is lower than to be in air, and water will tend to be adsorbed by the material, releasing the energy difference (the difference between chemical potential for water in the material from that in air) as heat. The converse is true when the material is moist and the air is dry. The chemical potential of water in hygroscopic material can change according to the amount of water absorbed.

The device and method of the invention are adapted to control temperature and humidity of the air in some defined volume such as a room in a house. The most basic system comprises a quantity of sorption material and means for passing air past or through the material. This air may come from outside or inside the volume to be cooled, and may likewise thence be passed to the outside or inside. Direct temperature and humidity control occur when air is conditioned and sent inside the room; indirect control is also possible, by affecting the temperature of the walls (the sorption material may occupy channels or spaces within the walls, which are then heated/cooled, indirectly heating/cooling the air in the room by conduction). A fan or blower will allow for forced convection of air in a desired path (e.g from outside the house, over/through the sorption material, and into the house, or in the opposite direction). A second fan and valves will allow for more complex operations as will be detailed below.

The basic method for operating the system involves heat and mass exchange between the sorption material and a source of air. A particularly single embodiment using a constant air flow causes a buffering effect, stabilizing both air temperature and humidity fluctuations. Buffering can occur for daily, seasonal, and yearly temperature and humidity fluctuations. For example: during the day time, the outdoor temperature rises and relative humidity falls. A constant flow of air from outside, through the sorbent material and thence to the inside of the room, will dry the sorbent material during the day (when the outdoor humidity is low) and wet the air, cooling it and thus keeping the interior air cooler than the outside air. In the evening when the outside temperature falls, humidity levels rise, and the now-dried sorption material will absorb moisture from the humid outside air, and heat it. In this way both temperature and humidity are buffered, flattening the peaks (of both temperature and humidity) and decreasing the amount of time any powered heating or cooling systems must be used. More advanced methods operate the system at specific times in order to cool, heat, dehumidify, humidify, and regenerate the hygroscopic material for further use, and may take into account forecasts of future conditions of outdoor temperature, and humidity, and desired ranges of these. These operations are carried out within limits allowed by the ambient humidity conditions and the saturation level of the hygroscopic material.

Many of the embodiments use heat and mass exchange between air and a sorbent or hygroscopic material. The heat exchange process can use conduction, radiation, free convection or forced convection in a direct or indirect manner.

One non limiting example for indirect heat transfer uses the envelope of an enclosure having an internal air gap or air volumes. For example, consider a building whose walls have internal air gaps or spaces. Air is blown through the air gaps in the wall. The sorption material may be in the air gap, for instance as a coating layer or porous material not impeding the air movement through the internal gap. In any case, by heating and cooling the air within the walls, the walls are in turn heated or cooled, and these in turn affect the interior of the room by surface radiation.

Air movement through the sorption material can be blocked to allow for maintaining the humidity state of the material, or facilitated to allow for regeneration (moistening) or activation (drying) in any of several ways:
1. Air can be conducted from indoors, through the hygroscopic material, and then back to the indoors, thereby stabilizing humidity and to some extent temperature peaks.
2. Air can be conducted from outdoors, through the system, and from there to the indoors, thereby stabilizing humidity and to some extent temperature peaks of the fresh air incoming to the indoor environment.
3. Combinations of both indoor and outdoor sources of air may be used for better performance.
4. In embodiments where there is no direct communication between the hygroscopic material and the ambient air, indirect access can be obtained by opening a window or a blower for introducing ambient air to the room that will eventually contact the hygroscopic material.

In general the operation of the system can be manual, or it may be controlled by using a controller, sensors and a set of user preferences, in order to bring the indoor air as close to the comfort zone as possible given system parameters and the ambient conditions.

The system can be totally passive or fully automated and controlled.

### Some Novel Embodiments

The invention is directed to reaching the ‘comfort zone’, this being a zone taking into account temperature and humidity (at least) rather than just temperature. The comfort zone definition can further incorporate factors such as wind speed, fresh air, air odor, air pollution levels, pollen count, radiation temperature, and surface temperature.

Since the only energy required is to operate fans for air flow and opening/closing vents, the system requires a minimum of energy when compared to traditional air conditioning systems, and has no water requirements.

Heating or cooling the building envelope instead of heating or cooling the interior of the building is an option that can be used with ‘active insulation’ (affecting the temperature of air gaps or channels within the walls) or in other embodiments that are presented. These approaches have great advantages especially in times when the system cannot heat or cool to the desired final room temperature. Heating and cooling the envelope can save much of the expense of cooling and heating, as outdoor air can be brought closer to the desired ranges of temperature and humidity for no cost, making any further heating/cooling step less expensive.

Another alternative is to condition (by which we mean control temperature and humidity) the fresh air incoming to the building, by use of the sorbent/hygroscopic materials and methods disclosed above. The system may be made more efficient by exchanging heat from outgoing air with the incoming air, for example using a heat exchanger.

Building elements having a high surface area for heat transfer, such as walls, can make the heat transfer efficiency high even at low-temperature differences. The low temperature difference required for heat transfer allows ‘deeper’ use of the energy reservoir in the sense that small temperature differences may be used for a large effect on the entire room volume, as opposed to a conventional air conditioner which affects only a small volume of air at a given time and thus generally is set to generate more extreme temperature differences than actually needed.

The system can utilize thermal mass as well. With this function, it has an additional advantage over most thermal mass systems, since the air can flow through/inside the material and it is possible to enlarge the available surface area for heat transfer enormously. By this means the effect of thermal mass, and the effects of absorption and desorption will be enormously amplified.

### 4. BRIEF DESCRIPTION OF THE DRAWINGS

Embodiments and features of the present invention are described herein in conjunction with the following drawings:

FIG. 1 shows the effect of relative humidity stabilising by constantly blowing air over sorption material.

FIG. 2 shows the effect of temperature stabilising by constantly blowing air over sorption material.

FIG. 3 shows a fresh air unit having sorption material tray and 4 inlet and outlet for different operation.

FIG. 4 shows wall with sorption material standing by a stove and blansing the temperature and humidity fluctuation it ceratas when operate and stos.

FIG. 5 shows wall with sorption material having a blower standing at the back of a stove and blansing the temperature and humidity fluctuation it ceratas when operate and stos.

FIG. 6 shows a stove that sorption material is integrated inside for blansing the temperature and humidity fluctuation it ceratas when operate and stos.

FIG. 7 shows an acoustic tile containing a sorption material and having airflow from outside through the sorption material and into the room.

FIG. 8 shows a tatami floor containing a sorption material and having airflow from outside or inside through the sorption material and into the room

FIG. 9 shows a ceiling acoustic element made from wet greenhouse pad containing a sorption material and having airflow from outside through the sorption material and into the room.

FIG. 10 shows a simulation of multi-reservoir systems where the x-axis shows time since the beginning of the experiment and the y-axis shows the state of moisture absorption of the material (gr water absorbed/gr absorber)

FIG. 11 shows a prior art of sorption graph of different sorption material.

FIG. 12 shows sorption material made from paper mass mixed with cesium chloride and attached to the lowerside of a tin roof.

FIG. 13 shows flexible sorption material made from paper mass mixed with cesium chloride.

FIG. 14 shows a side section cut of a wall having sorption material inside and different flow path.

FIG. 15 shows an assembly of a wall having sorption material inside.

FIG. 16 shows active insulation assembled on a wall having sorption material and ventilation means in an attached container.

FIG. 17 shows active insulation having an internal air gap.

FIG. 18 shows a cut section of an active cornice attached to the corner of wall and a roof, having sorption material and indoor vents.

FIG. 19 shows a cut section of an active cornice attached to the corner of wall and a roof, having sorption material, indoor vents and outdoor vent.

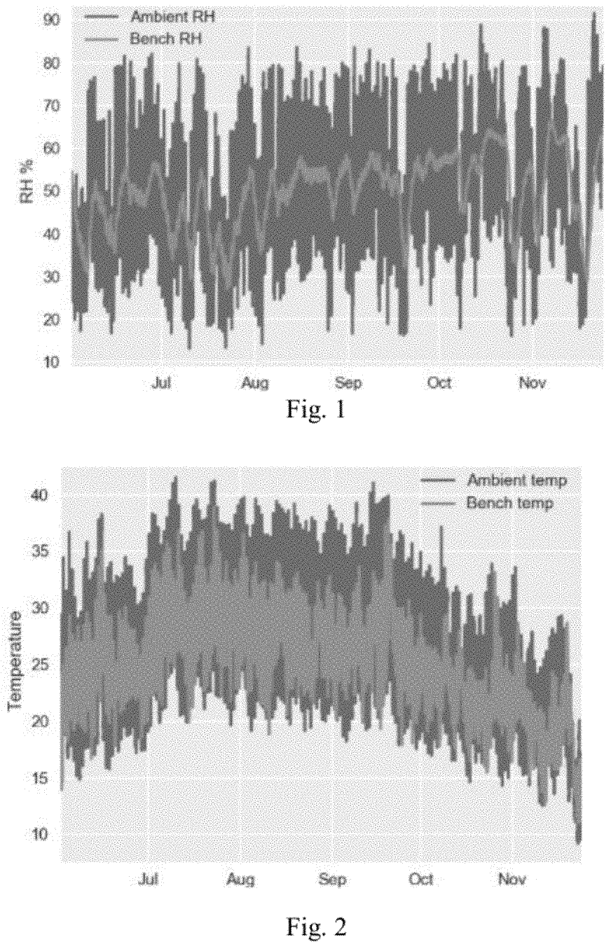

### 5. DEFINITIONS

Sorption material or hygroscopic material: material adapted to absorb relatively large volumes of moisture from the air (or water). The sorption material can be in liquid form or solid form, liquid absorbent impregnated on solid material, or combinations of these. Sorption material can generally both absorb and desorb moisture for many cycles, and heat upon absorption (sorption heating) and cool upon desorption (evaporative cooling).

The sorption material can be a solid like bentonite, a solution of salts like calcium chloride, a sorbent material impregnated in another absorbent material like plant fiber, or a combination of the above. Sorption materials suitable for use with the system include rice sheets, paper, wood wool, activated carbon, silica gel, cloth, cotton fabric, and the like. Many of these may also be improved by impregnation with other absorptive materials such as calcium chloride. Different combinations may also be used, such as water-absorbing salts combined with materials such as active carbon, wood wool, and bentonite.

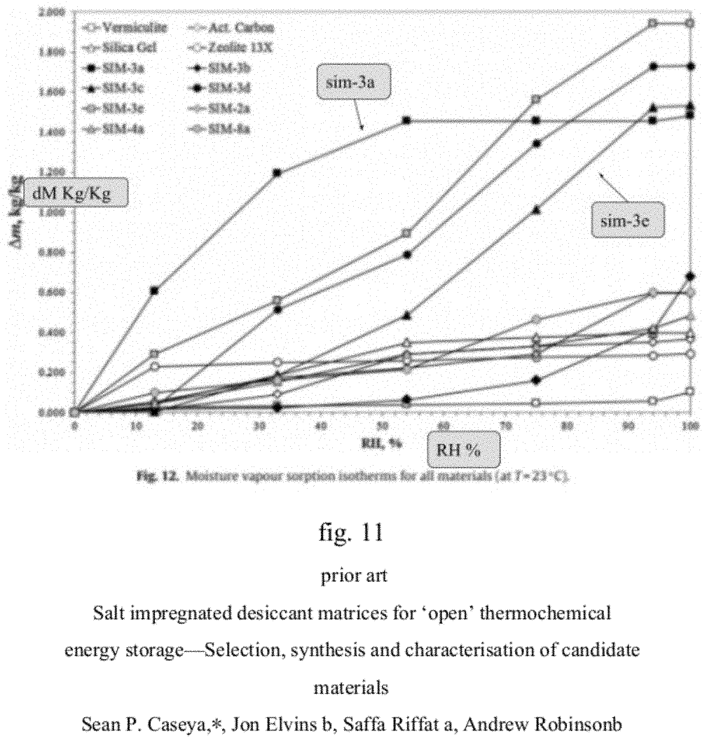

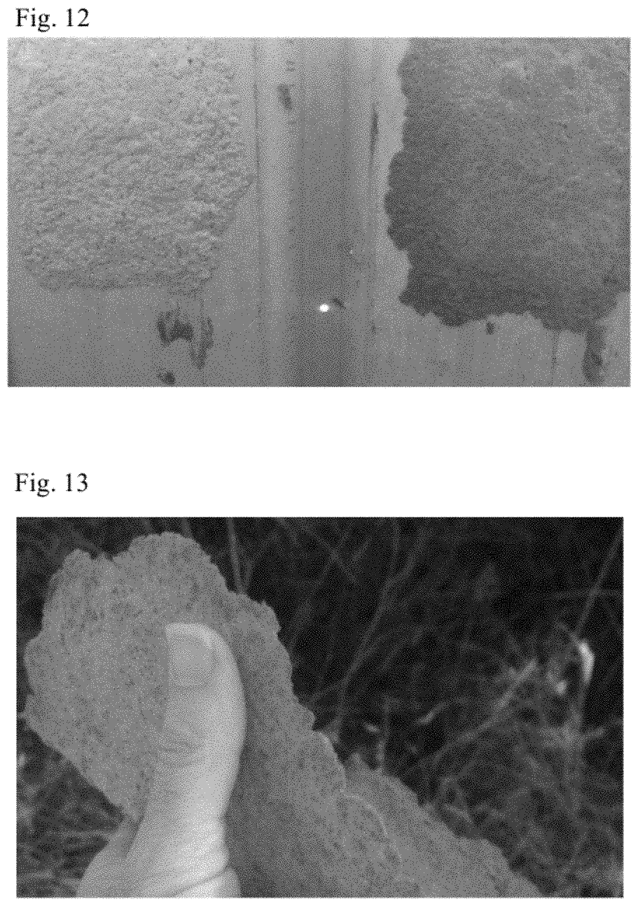

Liquid solutions may also work as well, for instance lithium bromide, aqueous calcium chloride, or calcium chloride in ammonia. Different materials can be designed for different climates. For example, calcium chloride impregnated into vermiculite has good humidity absorption in the dry conditions shown in FIG. 11 (sim 3a), while vermiculite impregnated with lithium bromide has good humidity absorption in the humid conditions of FIG. 11 (sim 3e)

Hygroscopic material: same as sorbent material.

Sorption reservoir: this is a volume containing sorption material. In simple embodiments the sorption reservoir is the sorption material itself, while in more complex embodiments the sorption reservoir may be divided into sub reservoirs that operate separately. In some embodiments the sorption reservoir is completely insulated from the environment, with all gas exchange prevented. In other embodiments it is partly scaled or not sealed at all, in which case the sorption saturation level is kept fairly constant due to low rates of mass exchange, compared to forced mass exchange while using the reservoir.

Liquid desiccant: a liquid sorption material.

Sorption heating: the process of water vapor binding to sorption material, thereby releasing heat. The energy released is a combination of the evaporation energy and binding energy.

Surrounding air: can be air that surrounds the system, or air that is outside or inside an object, enclosure, building, or structure.

Source of air: air available for use either inside or outside a space, object or enclosure.

Sorbent reservoir: a quantity of sorption material that can be fully, partially or not at all encapsulated from its surrounding air. The sorbent reservoir can be divided into subunits.

Air path: a flow path that air is conducted through, for example in order to expose sorption material to surrounding air.

Flow system: A system adapted to control a flow of air or other gasses, water, or both.

Saturation level sensor: A sensor adapted to determine the state of moisture absorption of sorption material. This can be a humidity sensor, conductivity sensor, a capacity sensor, a salinity sensor, a volume sensor, specific gravity, viscosity, scale, or any other sensor that indicate the amount of water in the sorption material. A relative humidity sensor for air that is in equilibrium with sorbent material is example of a simple saturation sensor. In order to compare the saturation level with air relative humidity, the saturation level is expressed as the relative humidity of air that is in equilibrium with sorbent material.

The saturation level of the sorbent material is measured as the relative humidity of the air that is above said sorbent material.

Monitoring water saturation level: This may be accomplished with saturation sensors, or by sensing the temperature or humidity difference of air before and after heat and mass exchange. Alternatively, this may be accomplished by estimating the saturation level using records of historical operation. Another method is to measure the temperature and humidity of air before and after exchange, from which the moisture transfer can be calculated and integrated over time.

Volume to be controlled: any region where it is desired to control the temperature and humidity, for example dwellings, rooms inside dwellings, air input to HVAC systems.

Air inlet and outlet: The inlet and outlet for air to enter into and exit from the system. Can be divided into several sub inlets and outlets. The air inlet or outlet can be just an unobstructed path for air to reach the sorbent material, but can also be a vent having a valve or not. The air inlet can have several sources of air for one system as indoor air, outdoor air, specific conditioned air and so on. In that case the controller can chose the air source. The outlet can have only one sink for one system.

In one particular embodiment there is only one air source, and the air sink and source are alternated. Thus the air flow direction is periodically reversed, thereby performing heat and mass recovery.

Exactly one air outlet: in the minimal embodiment air inlet can be just a clear way for air to go to the sorbent material, it can also be a vent having a valve or not. The air inlet can have several sources of air such as indoor air, outdoor air, specific conditioned air and so on.

liquid-to-air heat and mass exchanger: non limiting examples for heat and mass exchange include:
forcing a flow of a liquid-desiccant over different building surfaces, such as interior walls, exterior walls, and roofs; forcing a flow of air perpendicular to the flow of a liquid as in the operation of a desert cooler; forcing a flow of air through a liquid, potentially using means for diffusing air flow through the liquid; spraying a liquid into a body of air; heat exchange, without mass exchange; combining multiple heat and mass-exchange units of one or more of the above (thereby allowing a common reservoir for using best available conditions, whether they will be indoor or outdoor and allowing the outdoor activity not to influence the indoor air humidity).

user behavior pattern data: data concerning user behavior such as setpoints chosen, times of building occupancy, and the like.

humidity exchange membrane: this may be a water vapour transport membrane allowing moisture transport driven by mass transfer potential, and sensible heat transfer under temperature difference.

Predicted requirements for heating or cooling of an sorbent reservoir: to heat, the sorption material must be dry (drier than the air being used to flow through it), while to cool it must be moist (more humid than the air being used to flow through it).

Waiting state: A waiting state occurs when the flow control system does not allow or cause air flow. Under many conditions even if the sorption material is not in an airtight enclosure, the exchange rate is negligible if there is no forced air flow and heat exchange.

User's personal comfort profile: A user's preferences for ranges of temperature and humidity, and possibly other factors such as air speed, light levels, oxygen levels, etc.

Thermal mass storage: the system has thermal mass which can be used for heating or cooling. Airflow may be used (for instance) to cool the material at night, and then cool a dwelling during the day with air cooled by being blown through or past the cooled material.

heat source: this may be ambient air humidity fluctuations; waste heat; heat derived from heating heal pumps, HVAC equipment or other sources; dehumidified air, air heated by solar panels, ovens, kilns, or other sources.

Comfort zone: a range of temperature and humidity defined as comfortable, for example as according to ISO7730 between 20 C and 26 C and between 30% RH and 70% RH. The comfort zone as herein defined may also take into account air quality, wind speed, and other factors.

target range of combined comfort conditions: synonymous with comfort zone, this is a combination of several factors such as: air temperature, relative humidity, air speed, metabolic rate, clothing level, surface radiation. A few examples are: ASHRE55, heat index.

energy consumption or energy costs: the controller may take into account energy usage and/or energy costs. Due to tariff differences, the energy use does not necessarily correlate with energy cost; it is within provision of the invention to take this into account when planning optimal actions.

forecasts future: the system has a controller adapted to estimate the system's current and future capability to meet target ranges of combined comfort conditions, and to take actions that allow for meeting current and future predicted requirements. For example if a cold snap is expected, it will be useful to dry the material such that it can be used for heating. To dry the material, dry air of mid-day may be blown through it.

Active insulation refers to an insulation layer (such as that surrounding a building), that under some conditions, can heat up or cool down in a controlled fashion and thereby reduce dramatically the heat loss of the building. This layer is not only insulting but can heat or cool in a controlled, on-demand fashion by venting dry or humid air as described above. It can be implemented in roof, walls, and even car roofs.

### 6. DETAILED DESCRIPTION OF PREFERRED EMBODIMENTS

### A Simple Embodiment

One non limiting example of the system outlined above is a desert cooler which has had calcium chloride or other hygroscopic material added to its water reservoir. The remaining elements of the system can remain identical, other than to take into account the possibly corrosive nature of the desiccant, or change in viscosity that may change the pump requirements. In experiments we have conducted, we operated a desert cooler with added hygroscopic material for several months, without addition of water and without requiring any external maintenance. For the duration of the experiment, the system buffered external temperature variations; when the temperature fell, the system heated, and when the temperature rose, the system cooled. Physically this occurs due to release or capture of the latent heat of moisture in the air.

A further experiment shows that even in the case of complete solidification of the salt, as may occur after an extended dry spell, and at which point the pump stops pumping fluid, once humidity rose sufficiently for a long enough period, the salt still remaining on the absorbent pad of the device began to absorb moisture, and the pump started to pump again. The cooling pad continued to buffer the temperature even when the pump wasn't working.

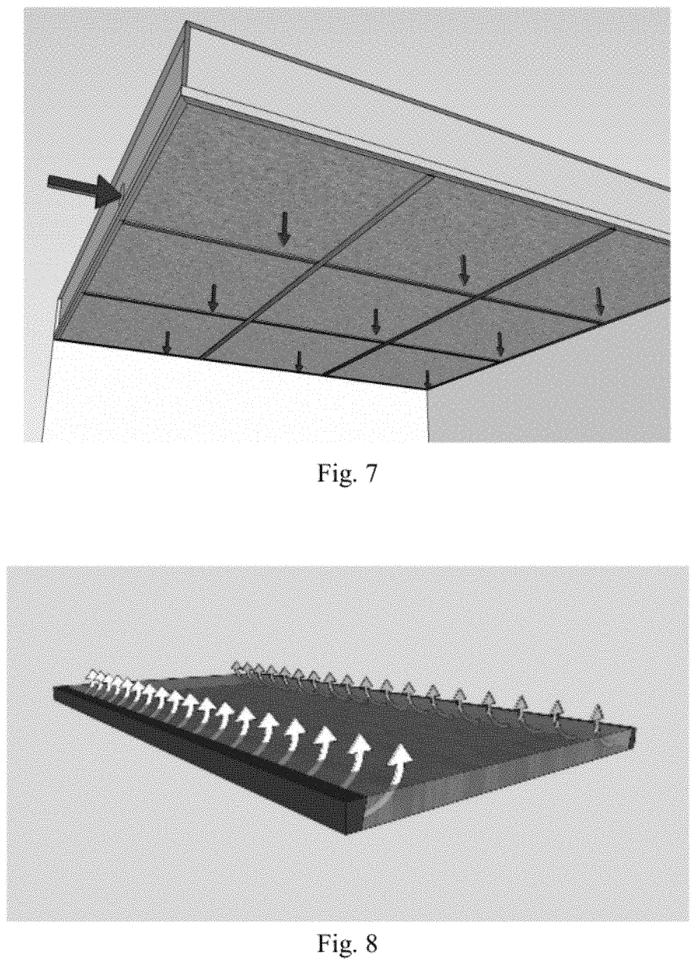

In light of these results, a further non limiting example is even simpler; a greenhouse cooling pad impregnated with calcium chloride, with no pump or water reservoir. Instead of the greenhouse cooling pad, other substrates may be used such as wood wool or materials made from wood wool, including insulation materials. One implementation of a system using these materials can be an acoustic ceiling as in FIG. 7, or a tatami floor as in FIG. 8. These implementations allow several functions for the device, as both building element and element for stabilizing temperature and humidity, and possibly even for improving air quality by absorption of dust and other materials. These embodiments may serve industry, home, or agriculture.

One possible use for the system in an agricultural setting may be to maintain temperature and humidity levels, as may be required for certain stages of growth, or for treating plant diseases, and the like.

FIG. 7 show a system for flowing air from outside into the dwelling and in this way the acoustic ceiling acts as a temperature and humidity buffer for the incoming air. However the incoming air alternatively may be supplied from the room itself. This may be desired for purposes of regenerating (or returning the salt to an original state of moisture absorption). Obviously these considerations apply to other implementations of the invention.

### Using Liquid-Desiccants

Another group of embodiments can be constructed by using liquid-desiccants that can be diluted and heated when humidity is high or concentrated and cooled when humidity is low.

Heat and mass exchange can occur in one or more of the following ways;
a. forcing a flow of a liquid-desiccant over different building surfaces, such as;
   i. interior walls, thereby having decorative value as well as humidity and temperature control, and large surface area for heat transfer, allowing to more fully use the energy reservoir by exploiting low temperature differences.
   ii. exterior walls, thereby having the above benefits and the benefit of even larger surface areas for heat and mass transfer, and the possibility for cooling or heating the envelope making it possible to more fully use the energy reservoir by exploiting low temperature differences, that might not otherwise be useful for heating or cooling the interior.
   iii. Roof, having the above benefits and further having the option to utilize the energy from the sun and the night radiation to the sky together with exploiting the ambient hot, cold, dry or humid air.
b. forcing a flow of said liquid over a surface and forcing a flow of air perpendicular to the flow of said liquid as in the operation of a desert cooler thereby allowing a variety of embodiments like using well known common technology, used in greenhouse and dwellings, that until now is used just for cooling and humidifying, improved by means of the provisions disclosed herein for use in heating and dehumidifying as well;
c. forcing a flow of air through said liquid, potentially using means for diffusing said air flow through said liquid;
d. spraying said liquid into a body of air;
e. heat exchange, without mass exchange, in any common way like using indoor or outdoor radiators, underflow heating systems, forced convection fins and so on;
f. combining multiple heat and mass-exchange units of one or more of the above, thereby allowing a common reservoir for using best available conditions, whether they will be indoor or outdoor and allowing the outdoor activity not to influence the indoor air humidity.

These means allow the operator to exploit the ability to transport the liquid-desiccant through hoses or pipes for purposes of activation, regeneration, using indoor environment, outdoor environment, different facilities for heat and mass exchange, direct cooling or heating. An example is pumping the liquid-desiccant under the floor, to allow: using said liquid-desiccant for floor cooling or heating. Another example involves using said liquid-desiccant for heating, cooling, humidifying and drying greenhouses by use of the common greenhouse ‘wet pad’ that until now have been used just for cooling and humidifying. A further example is using said liquid-desiccant for pre cooling/pre heating heal pumps or HVAC equipment, and so on.

### The Use of Liquid-Desiccants on Walls or Roofs

Walls and ceilings have large surface areas for heat exchange, which can be exploited for a large effect oven with a small temperature difference. External walls may be used in the following way. A hygroscopic solution may poured down the external facing side of the wall in a cyclic fashion, forming a sheet of liquid pouring down the wall. This allows cooling or heating of the building envelope, thereby decreasing the cooling/heating load upon the building.

Interior walls may be used similarly to as surfaces over which sheets of fluid may be conducted, for large-scale heat and mass transfer. This will act as the case of external walls with the added advantage of allowing for large scale increases or decreases in the room humidity. As will be clear to one skilled in the art the humidity plays a significant role in determining the comfort lev el of mom occupants, in conjunction with the temperature defining a ‘comfort zone’.

Similarly, conducting a flow of liquid over the roof of a building allows for a large area for heat and mass exchange with the external air, and allows for heating or cooling large areas of the building envelope. In addition this allows for evaporation by means of the sun's radiation, allowing for concentration of the solution such that it is now ready to absorb more moisture.

### Additional Embodiments

Other novel elements may be used in combination with the effects mentioned above including:
1. Heat and mass exchange can be accomplished by using a hygroscopic liquid on different building surfaces such as the roof, external walls, or interior elements of the building.
2. The element in which the solution flows may also give further benefit such as an aesthetic experience, the sound of flowing water and the like. It is possible to flow air through the liquid or the liquid through air to facilitate heat and mass exchange.
3. Use of the system to stabilize humidity in a space, to improve thermal comfort, prevent condensation, remove airborne particles, and other benefits.
4. Use of the system may also allow treatment of air quality, for example by trapping small dust particles. Use of certain salts is also known to have health benefits.
5. Use of the system to stabilize the daily variations in temperature, by cyclic absorption and evaporation matching the changes in external humidity—when the temperature rises and humidity decreases, moisture will evaporate from the hygroscopic material producing a cooling and humidifying effect countering the external changes, and at night when the humidity increases the material absorbs this extra moisture producing a heating effect countering the external decrease in temperature.
6. Addition of a system for data logging and control is useful for controlling when to operate various system elements for maximum benefit of thermal comfort and best future operation of the system. This can be done by using data on humidity and temperature inside and outside the building, and the state of absorption (water content) of the hygroscopic material.
7. The system as described to which is added a humid air input unit controlled by the controller described above. Control over the air flow into the building can improve matters in several ways:
   a. Introducing air that is closer to the thermal comfort zone automatically, without the user's intervention. For example, controlling the airflow by considering the differences between external and internal temperature and humidity and the expected future requirements.
   b. Allowing the system to regenerate moisture/dryness levels of the hygroscopic material in anticipation of future needs. For example in the summer if the humidity outside is low and the temperatures are not too high, exchange of large amounts of air can concentrate the solution (reduce the amount of water therein), making the material ready for night time when the humidity rises and temperatures fall.
   e. Improvement of room air by means of introducing fresh air from outside.
8. The system described in 7, where instead of a unit for introducing humid air, the system gives building occupants indication that opening windows will improve thermal comfort. This system can be simpler than that of section 7 while still being effective in many cases.
9. Introducing humid air by use of the absorptive material can improve the air quality before it enters the room.
10. Use of an entirely internal mechanism for heat and mass exchange, with piping connecting the outside air to the system and the system to the inside air.
   a. This allows regeneration by harvesting ambient humidity/dryness without affecting the internal building air. Thus for example if the building interior is already within the comfort zone but it is anticipated that heating will be needed at night, the hygroscopic material may be dried by running external air through the material and back outside, thus preparing the material for heating at night while not driving the internal temperature down.
   b. This also allows for control over when to introduce external air or direct internal air outside, allowing for optimization of thermal comfort.
c. Use of small doses of concentrated solution outside the building for purposes of heating or humidity harvesting. As soon as the solution reaches a certain level of dilution (due to water absorption) and there is a need for greater absorption for heating or drying, a new dose is introduced.
d. Use of a controller with an algorithm making use of weather prediction and measurements of temperature and humidity inside and outside the building. By defining parameters of thermal comfort and knowing the state of absorption of the hygroscopic material, the system can be employed to dry or add moisture to the hygroscopic material, and for cooling and heating the building, to bring the system to an optimal state for present and future operation.
11. Use of salts or mixtures of salts allowing for use of the system in different climates. For example sodium chloride above 75% RH will absorb water and liquefy, while below 75% RH its absorption is negligible. This material may thus be used in climates that vary in the range of 75% RH or more an appreciable fraction of the time. Another example would be for dry climates where the humidity changes are generally between low levels, e.g. between 20% and 40% RH. Materials that absorb large amounts of moisture between these levels can be used to buffer humidity in these regions.
12. Multi-reservoir systems. Here several different units of hygroscopic materials are used. The effects of temperature change (cooling and heating) are more pronounced as the difference between external humidity and the ‘equilibrium humidity’ (that is, the humidity of air in equilibrium with the material) of the material increase. Since the equilibrium humidity of the material changes as air is forced through it, different units can be used to counter the decrease in effectiveness as it exchanges moisture with the incoming air. An example for control of such a system is referred to in FIG. 10. This shows a simulation using meteorological data of humidity. The x-axis shows time since die beginning of the experiment and the y-axis shows the state of moisture absorption of the material (gr water absorbed/gr absorber). Each color shows the state of a different unit. At the beginning of the experiment each unit is at its own initial state of moisture absorption. When the system is set for heating, the unit at lowest level of moisture absorption is exposed to external air and the rest are regenerated for future use. In a state of activation for heating, the system waits for a state in which humidity in the air is greater than the equilibrium humidity of the material, and when this occurs air is forced through the material. Drying is done when conditions permit, ie when the humidity of air is lower than the equilibrium humidity of the material. In FIG. 10 one sees that at the beginning of the simulation the gray line shows that the unit undergoing absorption its equilibrium moisture rises and the rest are not being used.

Another use of such a system would be to separate the air treatment into phases of humidification/dehumidification and cooling/heating. For example one unit may be in thermal contact with the ambient. Outside humid air is run through the relatively dry material, which heats and dries the air. This air is brought closer to ambient temperature due to the thermal contact with the ambient, and is then brought into a second unit have relatively wet hygroscopic material, which can then effectively cool the dry air which starts near ambient and then is cooled below ambient. One challenge here is to regenerate the first unit to dry conditions. A way to do this is to have a large mass of material and opportunistically dry it at infrequent intervals of unusually dry weather (e.g. during the ‘khamsin’ winds, ‘Santa Ana winds’, or other dry conditions).
13. embodied as furniture like a bench or sofa.

### Detailed Description of a Specific Application:

The aforementioned provisions may all be used in the following embodiments.

### 1. Fresh Air Unit.

Fresh air unit stream fresh air into the building, some of the units heat or cool the air that they blow into the building ether by heat pump or by heat exchanger. The innovation uses the describe absorption and desorption of water to cool, heat or humidity stabilization by the following system:
1) Basic system, constant blowing of fresh air from the ambient into the indoor environment. It was shown in our long term experiments that simply blowing fresh ambient are through hygroscopic material stabilize its temperature and humidity. FIG. 1, 2 show experimental data of temperature and relative humidity (RH) of air before (ambient temperature and RH—blue) and after (bench temperature and RH—green) blowing it constantly over hygroscopic material. The hygroscopic material goes through cycles of absorption and desorption performing cooling and heating, balancing the temperature and relative humidity with no control or any mechanical input other than constantly blowing air from ambient through the hygroscopic material
2) Control system, one or more of the following means:
   Temperature sensor
   relative humidity sensors
   A second path for blowing air: from outside air through the hygroscopic material back to the outside air
   A third path for blowing air from inside air through the hygroscopic material back to the inside air
   A fourth path for blowing air from outside air to the inside air without going through the hygroscopic material.
   air blower system and vents capable of opening and closing vents to restrict air flow in one of the four paths mentioned, or a fifth action of restricting all air exchange.
   A controller determining an expected effect of the five possible actions described above. If one of these actions is found to bring interior conditions closer to predefined comfort zone conditions, then this action is taken. There could be different algorithms as will be discussed.

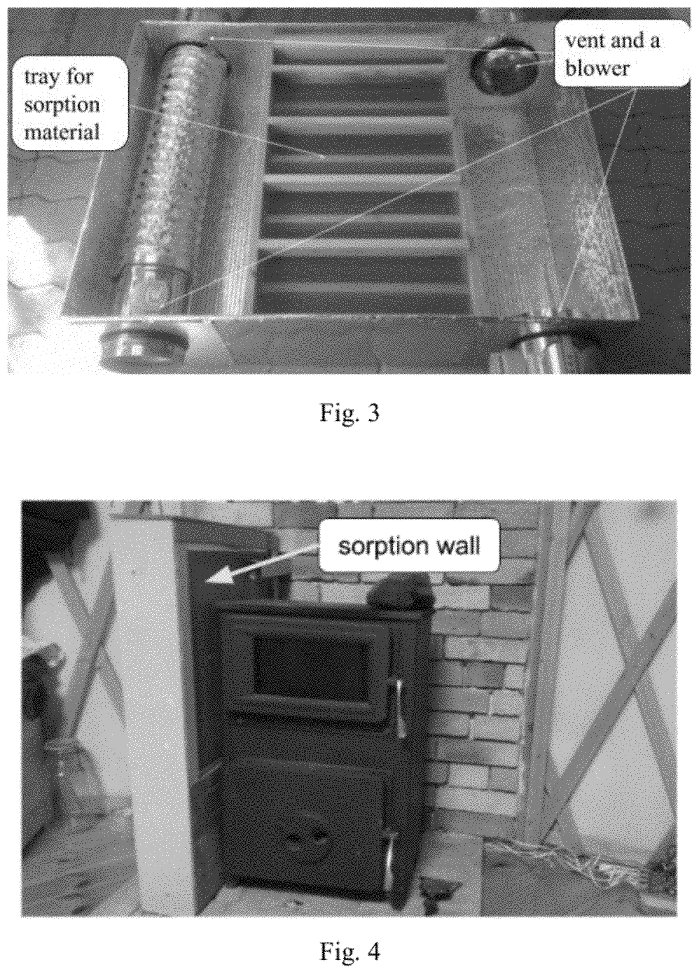

FIG. 3 shows an example of a prototype having 4 controlled vents, 4 blowers and a set of ‘drawers’ for containing the hygroscopic material.

This system can operate in all the ways mentioned before, for example: air may be forced or allowed to flow in some or all the following ways:
1. from outdoor to indoor passing through the sorbent material.
2. from outdoor to indoor not passing through the sorbent material (just fresh air).
3. from outdoor to outdoor, for regeneration or cleaning process.
4. from indoor to indoor.
5. different combinations of the above.

The methods mentioned may be combined with other systems:
air purification to remove dust, VOCs, NOx, and more. One of the proposed materials for the absorptive material can be activated carbon, known for its ability to purify the air. Using such a material allows for both purification and humidification/dehumidification at the same time.
Heat exchanger, that recovers energy from the outgoing air to the incoming air.
Other means for heating and cooling to provide accurate performance even when the absorption heating or evaporative cooling can't reach the needed temperature.
Energy storing option: using low cost energy (e.g. energy bought at times of low tariff) for drying the sorbent material and performing absorption heating later on when the tariff is high.
adding water to make more use of the evaporating cooling possibility.

Material that can be used could be any absorbent material as well as different combinations, such as water-absorbing salts combined with material such as active carbon, wood wool, and bentonite. Liquid solutions may also work as well, for instance lithium bromide, and calcium chloride. Different material can be dizend for different calumet, for example calcium chloride implemented on vermiculite have good humidity absorption in the dry conditions FIG. 11 (sim 3a) or vermiculite impregnated with lithium bromide have good humidity absorption in humid conditions FIG. 11 (sim 3e)

### Heat and Mass Recovery From Exit Air to the Incoming Air

In one embodiment of the invention, the area to be conditioned is at least partially or completely sealed, and a controller is used to employ a heat and mass recovery state. This state requires only one air inlet. Air is alternately pulled into and pushed out of the area to be conditioned at predefined intervals. By doing so, this method allows for both heat and mass exchange of the inside air with the sorption material, and heat and mass exchange of said outside air with the sorption material. Multiple such units may of course be used in parallel, some of said systems are in said first state and others are in said second state.

### 2. Mass Stove, Wood Burning Stove, Heat Storage Stove, Heat Storage Heater.

sorption-desorption energy storage for use with stoves/ovens/fireplaces.

A stove element that absorbs/desorbs heat and humidity, used to store and release energy coming from a wood stove is shown in FIG. 4, 5, 6 or other ovens or way to heat (even for baking).

When operating a wooden stove the temperature goes up, generally to a higher peak than that requited for heating the room, and then rapidly falls when the wood burns out. Since air is drawn in for combustion, interior air is used and exterior air eventually replaces it. This can result, overall, in a net effect of cooling rather than warning a room using a stove. One way to balance the undesired temperature fluctuations noted above is by using a Rocket Stove or other form of Mass Heater, in which a thermal mass absorbs the heat and releases it more slowly, levelling the stove's heat output and extending the useful heating time from a given amount of wood. However these stoves need hundreds of kg and more of mass, and makes initial heating take more time.

Our invention uses the absorption desorption mechanism (mentioned above) in order to absorb heat when the oven is releasing heat aid released later.

Using this mechanism has several benefits:
1. The mass needed to store the same amount of energy will be an order of magnitude smaller, for example a few dozens of kg instead of hundreds due to the high latent heat of water.
2. The mechanism balances the air humidity:
   a. When the stove heats and the relative humidity of the air goes down, passing this dry air through hygroscopic material will add humidity to the passing air and cool it to moderate the temperature by reducing the unnecessarily high peak.
   b. When the stove stops working and the temperature goes down, the relative humidity goes up. At this time, passing this humid air through dried hygroscopic material (such as that dried by the previously described heating phase) will dry the passing air, heating it and again balancing the temperature by extending the healing period. The mechanism can be fitted with means for promoting or preventing humidity transfer, thereby allowing the user to store the heating/cooling potential and to release it at a chosen later time.
3. the same mass that is used for absorption and desorption can be used as a thermal mass as in a mass heater.

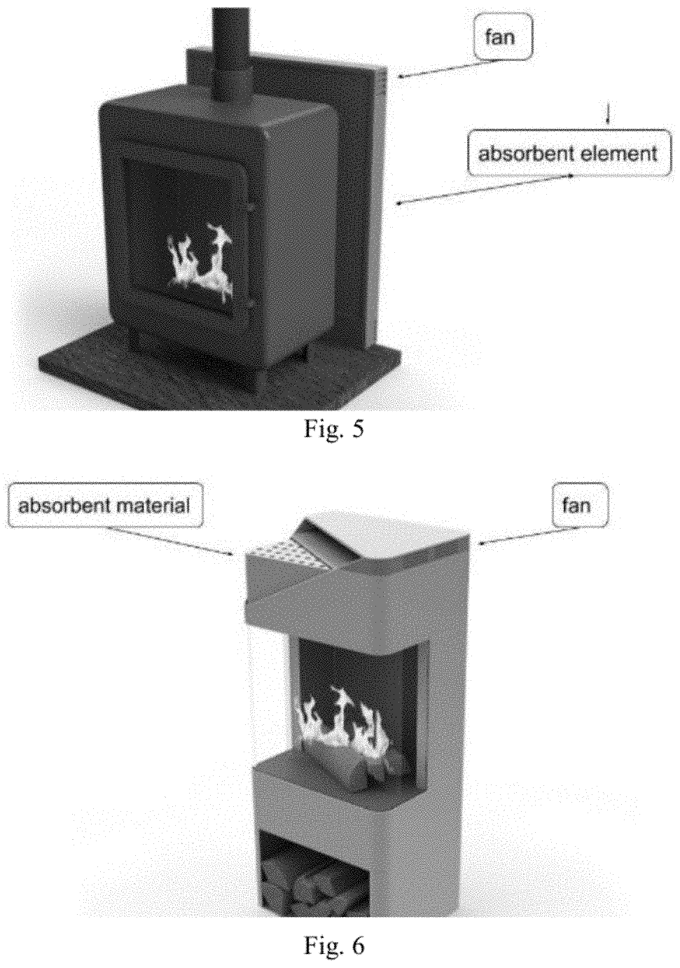

FIG. 4 shows a non limiting example of an absorption-desorption energy-storing system in the form of a wall comprising hygroscopic material, installed next to a stove, FIG. 5 show an absorbing element behind the stove and FIG. 6 shows absorbent material integrated into the stove.

Another embodiment uses hygroscopic material added to the stove walls, or integrated in the stove or oven pipe.

Some hygroscopic materials are commonly used in the ceramic industry which can allow the manufacture of moisture-absorbing bricks that a stove or part of a stove can be built from, or placed near to. Such bricks can be used in open fires as well.

Ventilation can be accomplished by natural ventilation, by natural ventilation using temperature differences, or forced ventilation. Different porous structures or structural designs can allow higher surface area and ventilation channels, exposing large surface areas of the hygroscopic material for faster moisture exchange.

Other methods of integrating the hygroscopic material are possible, such as coatings of the stove, or a hollow wall of the oven that is full of hygroscopic material. The material will generally have air channels and ventilation means.

The system can include means for actively forcing air through the hygroscopic material or may employ passive air flow.

A controller and humidity and temperature and/or humidity sensors can be added to the system in order to optimize the operation. For example, the system may harvest dry conditions (by adding moisture) if and only if the room is hot enough (harvesting dry conditions cools the air), and likewise may dry the air (and heat by so doing) only if the temperature goes below a given minimum temperature.

Another non limiting embodiment can be a structure around the part of the flue leading from the stove to the wall or ceiling of the room. This structure can be pre-assembled or post assembled on an already existing oven. The structure may use the surface area of the pipe and the possibility for natural convection, forced convection or both.

The simplicity of just blowing or passive air movement through hygroscopic material has great benefits but an improvement of the outcome can also be achieve in a system where the air flow is controlled for operation or not. Another improvement can be found if the air directed to the hygroscopic material is chosen from indoor air or outdoor air, and if the exhausted air removed from the hygroscopic material is directed either to the outdoor environment or into indoor environment.

Humidity balancing is provided by a simple embodiment which can be used solely for humidity balancing (humidifying the air when the stove/heater works and dehumidifying it when the temperature goes down and condensation might occur). This could happen passively or actively, e.g. using means for blowing air. A controller might be added for operation based e.g. on temperature and humidity thresholds defining a comfort zone.

Another implementation uses a convection unit, fan convector, or air conditioning unit that dries the air during operation. The system incorporates a moisture absorbent material at the outlet, and is capable of the following functions:
a. hydrate the dry air coming from the heater.
b. absorb humidity when the temp goes down and humidity rises, thereby:
   1. preventing high humidity, that might condense or create mold.
   2. prepare the sorbent material for the next hydrating cycle.
c. release heat when the heater is not working.

Functions b. and c. could operate in a passive way or by using a blower. The systems may also be controlled to reach a target relative humidity and or temp. Other control elements could be used, for example for switching the air from passing through the absorbent material or directly to the room. The system could also operate in specific time of the day, utilizing the low cost electricity tariffs.

### 4. Acoustic Ceiling Acoustic Wall, Acoustic Wall Element Acoustic Office Cubicle and Cornice.

The principles discussed above can be embodied in various building elements such as floors, ceilings, or tatami mat floors (FIG. 8), acoustic tile ceilings (FIG. 7), acoustic walls, acoustic elements, regular walls, indoor walls, acoustic screen, acoustic office cubicle, acoustic wall, ceiling elements or cornice. These elements may be designed to hold large amounts of hygroscopic material and/or be partially or entirely built of hygroscopic material. By introducing suitable channels and means for air circulation therethrough, these elements may be used to buffer the daily (or seasonal yearly) temperature and humidity fluctuations of incoming air. In some embodiments the air may also be filtered from particles or purified from other air pollutants. The potential sources and sinks for the airflow may be both inside the room and the outside ambient air, given suitable switching means.

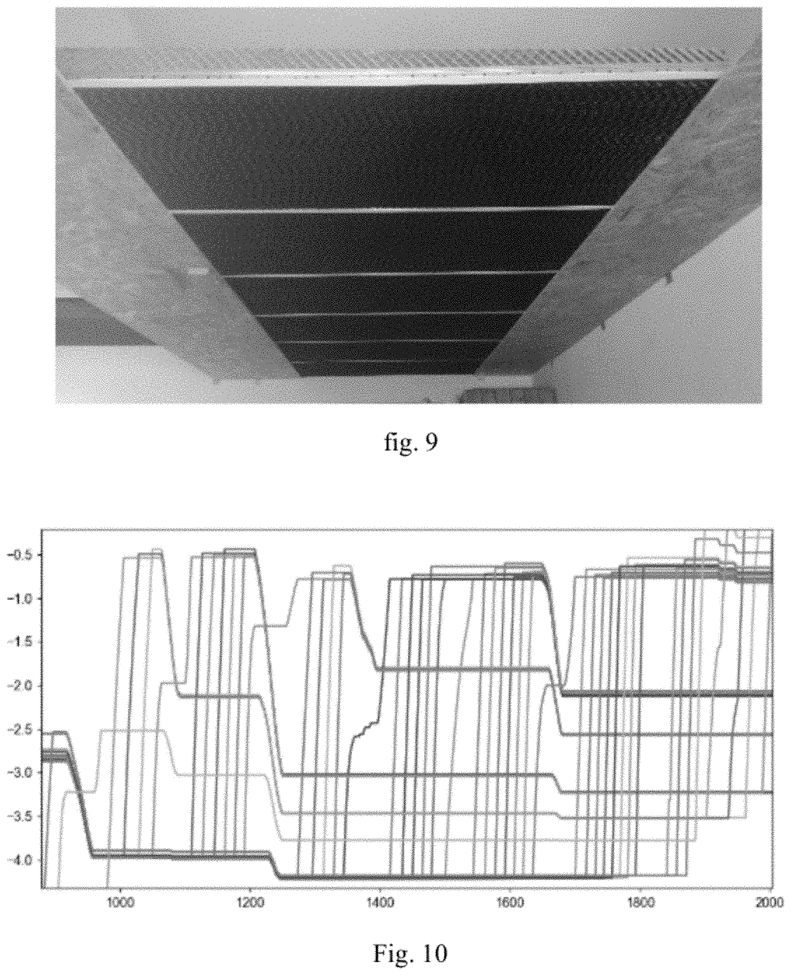

Passive heat and mass transfer may be obtained by allowing natural air movements and diffusion. Making highly porous materials e.g. with large channels, can promote such natural diffusion. A non limiting example of acoustic element or ceiling, can be by using a greenhouse cooling pad (FIG. 9). After impregnating this pad with a hygroscopic solution like calcium chloride or mixture of calcium chloride with bentonite in order to make a thicker layer. The large air channels can enable passive heat and mass transfer even if there is no forced ventilation.

Different embodiments can operate for different purposes: humidity balancing, cooling, heating or other combinations. This element can perform as fresh air unit as well, balancing incoming air temperature and humidity and optionally purifying the air.

There can be different embodiments:

A basic system, having just passive air movement allowing free convection, diffusion, natural air movement and so on. The system may be for just for balancing relative humidity.

Another system can be for temperature balancing along with balancing relative humidity.

A control system that comprises one or more of the following means may be used:
Temperature sensor
relative humidity sensors
blower and or other means for facilitating air movement allowing one or more of the following paths:
   i) A first path for blowing air: from outside air through the hygroscopic material to the inside air;
ii) A second path for blowing air: from outside air through the hygroscopic material back to the outside air;
   iii) A third path for blowing air: from inside air through the hygroscopic material back to the inside air:
   iv) A fourth path for blowing air: from outside air to the inside air without going thru the hygroscopic material.
An air blower system and vents capable of opening and closing to restrict air flow in the fourth path mentioned, or a fifth action of restricting all air exchange.
A controller determining an expected effect of the five possible actions described above. If one of these actions is found to bring interior conditions closer to predefined comfort zone conditions, then this action is taken. Alternative algorithms may also be used, as will be discussed.
Combining humidity control and temperature control. In this way the system has more options to achieve desired comfort conditions.

### 1. Indoor Fountain

The innovation of balancing indoor air humidity and temperature can be implemented in an indoor fountain that usually is used just for its beauty and sound. All the above principles can be implemented in such a product, which can be large, for public places or small for a domestic room. more explanation can be seen in the Using liquid-desiccants paragraph.

### 2. Active Cornice

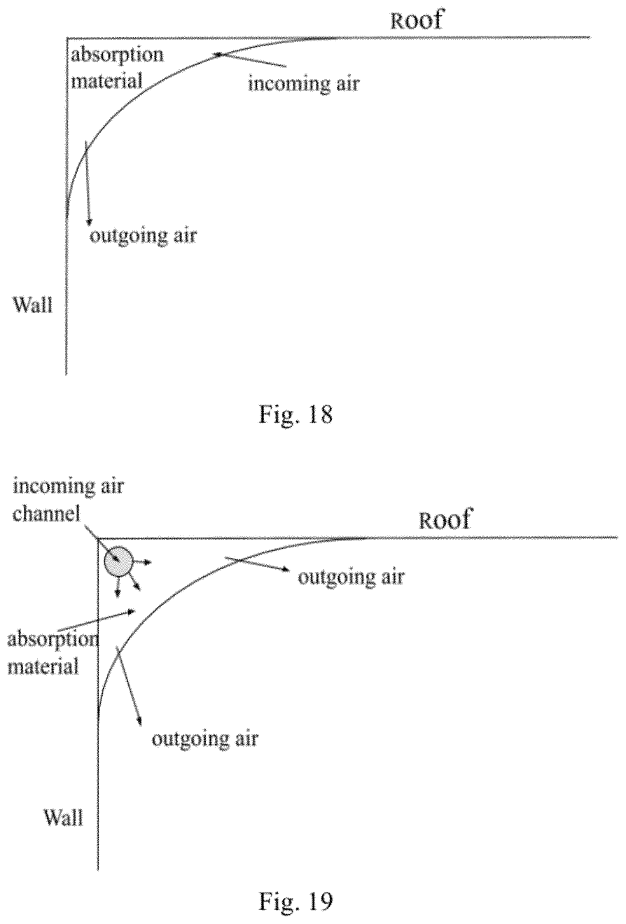

Cornices are attached to the wall and roof corners. A hygroscopic material can be embedded in the cornice and activated passively or actively in the same manner described in paragraph 3 (concerning the acoustic tile). FIG. 18 shows a non limiting illustration of such a cornice. Other air flows can be implemented as can be seen in the non limiting example in FIG. 19. Combining the solutions illustrated in FIGS. 18 and 19 can allow for flexibility in using different air sources (indoor or outdoor) thereby giving all the possibilities describe in paragraph 3 above (acoustic tile).

### 3. Active Lamp

Another indoor element that could carry sorbent material is a lamp, either a table lamp, standing lamp or ceiling lamp. The lamp may use a liquid-desiccant that will operate as discussed in “Using liquid-desiccants” above. Lamps have an electricity connection so ventilation means could be easily added, and the lamp heat itself can help regeneration.

The common “salt lamp” can be dramatically improved by one or more of the following methods:
improve ventilation by adding forced ventilation and or adding channels for air flow.
enlarging surface area so increasing evaporation absorption capability and rate.
using different hygroscopic material for different points of humidity equilibrium (different absorbent material have different humidity equilibrium point, so different humidity conditions can be achieved)
adding humidity sensors and a controller for operating fan and/or heating (that could be heat from the lamp's light source), such that a calculated action can be taken to improve indoor humidity conditions.
   The controller can be designed to maintain or stabilize certain humidity conditions by one or more of the following actions: heating (e.g. lighting the lamp's bulb), forcing air flow, operating a blower introducing fresh air, or even recommending the user to open a window.
   These actions can be carried out in order to maintain the comfort humidity zone or prepare the material for further expected actions (by drying or adding moisture to the absorbent material). In this case, in addition to the sensors, the controller can use weather forecasts or other databases.

### 4. Active Insulation

Some material, like cellulose, for a non limiting example, have both insulation and absorption properties. If the adsorbing layer comprises insulating material then we can create a novel “active insulation”. Wood fiber impregnated with absorption solution can improve the active insulation absorption properties.

The “active insulation” is an insulation layer, that under some conditions, can heat up or cool down in a controlled fashion and thereby reduce dramatically the heat loss of the building. This layer is not only insulating but can heat or cool in a controlled, on-demand fashion by venting dry or humid air as described above.

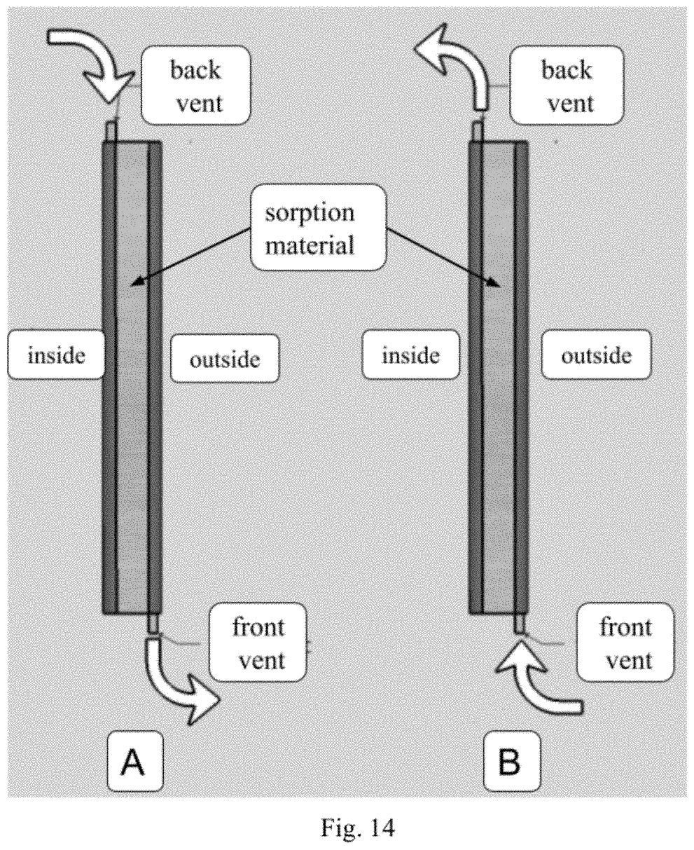

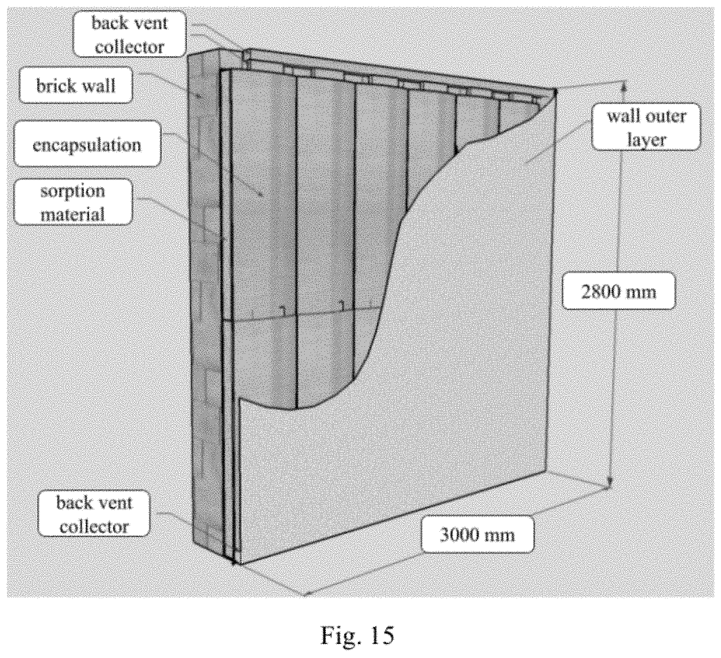

FIG. 14 shows non limiting examples of an embodiment of the invention wherein air flow through the wall, from inside to outside (A) or from outside to inside (B) while the sorbent material is inside the wall. FIG. 15 shows an assembly of such insulation. this embodiments can be for other material then insulation.

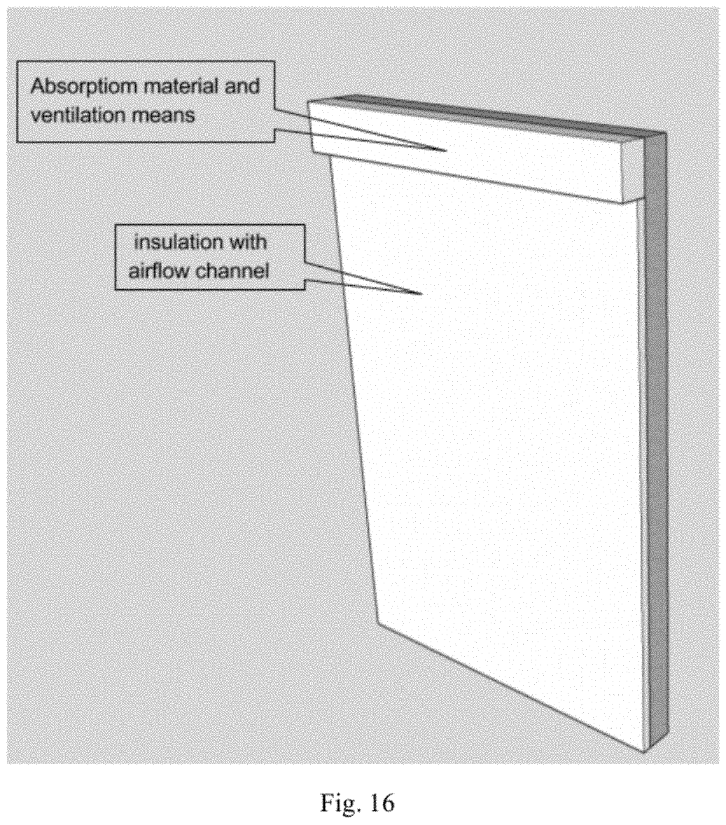

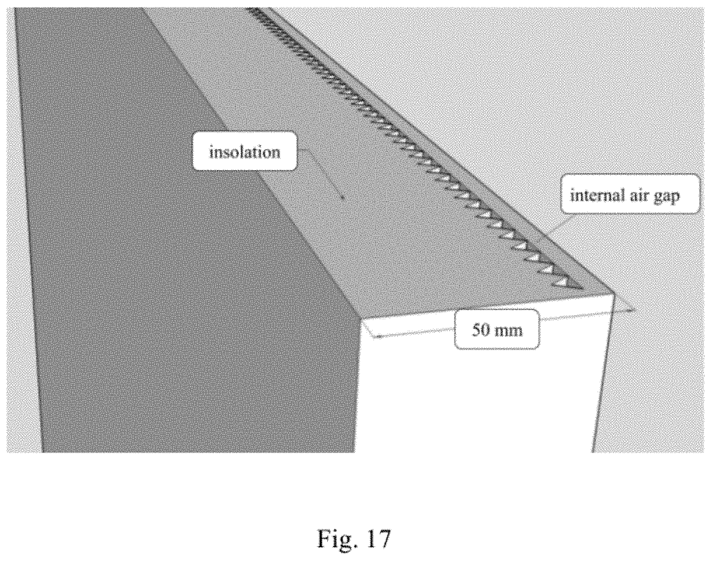

Another method uses the active material separate from the insulation, as can be seen in a non limiting example in FIG. 16. FIG. 17 shows the non limiting example of insulation, having an internal air gap or air channels that the heated or cooled air can flow through, thereby heating or cooling the building envelope.

### Roof

In the summertime the roof is exposed to major heat loads. By using sorbent material integrated into the roof, one can reduce those heat loads using evaporative cording. Restoring the moisture can again be accomplished by absorption of the night time humidity.

In the winter time this process can be used to heat the roof by absorption heating. The material can be used to absorb moisture during the night, thereby heating it, and to release the moisture to the atmosphere during the less humid day. In both these cases (heating and cooling) if there are alternative means for regenerating the moisture/dryness of the material (for example solar drying, spraying water directly from a water source, etc), these may also be used in addition.

A further example involves spraying a mixture of sorbent material and bonding material on the downward facing side of a tin roof.

One way for implementing this technology for the embodiments mentioned above is by use of an absorbent coating.

One non limiting example for this idea can be seen in FIG. 12, where two paper mache samples were attached to the lower side of a tin roof. The sample on the right was mixed with calcium chloride. Both samples dried completely but then, during the night the sample with calcium chloride absorbed moisture from the air (this can be seen as a darker color of the right sample). During day time, the water evaporates, lowering the temperature of the tin roof compared to the second sample, and similarly was cooler than the roof without any sample.

Coatings can be with different mixtures including different layers, for improving attachment, strength and absorbing capability. The coating can be implemented by spraying or by blowing.

FIG. 13 shows a flexible absorbing material that can be attached to different surfaces as roof, photovoltaic panels, stove, stove chimney, walls, treat exchangers, electronics, cars, cars ceiling, lampshade and so on.

This coating can be used for temperature balancing and humidity balancing. A humidity-dependent color-changing material may also be used here to indicate how much moisture the material has absorbed.

Active spray insulation is example just one way for implementing the technology; other ways can be used, for example as a panel that works on the same principles, having air channels. Another way is to have the active material in a separate tank, blowing the conditioned air through the material. This can be for other part of the building as walls and floors

### 5. Car and Other Vehicle

A Car and other vehicles roof roof can also benefit from embodiments of the innovation. A car provided with an active insulation or hygroscopic cooling system as described above could save energy on heating and cooling. This could have great advantages for electric cars, trucks, and public transportation means such as trains, busses, or other vehicles. It could have another benefit by cooling and heating the vehicle when parked. Its low energy operation could use small photovoltaic panels or the car's battery without emptying it. It can make the car temperature safer especially in hot climate when temperature inside the car could be deadly.

For cold temp, the regeneration could also obtain by heat coming from the hot engine.

The car engine's heat energy can be stored by drying absorbent material. This energy can be used for further heating the car or the engine itself (that can make it easier for starting the engine in cool morning for example). Heating can be performed manually or automatically according to desired times. This possibility can be combined or not with the car's roof.

Electric vehicle batteries need cooling. The invention can harvest cooling water in the high humidity of night time for evaporative cooling during peak use hours of day time. Heat and mass transfer can occur using a humidity exchange membrane, so if liquid-sorbent is used there is no problem of water spillage.

### 6. Pro Heating and Cooling For Air Conditioners

An embodiment of the system may be fashioned for evaporative cooling or condensation heating of air incoming to a heat pump. This may operate in conjunction with the air conditioning system, improving performance and saving electricity. The external unit of a heat pump exchanges heat with the surroundings. The novel system may be located adjacent to the heat pump heat exchanger and allows four modes of operation:
a. Heating the air with which the system exchanges heat when desirable and possible given the ambient conditions and state of moisture of the hygroscopic material:
b. Cooling the air with which the system exchanges heat, with the same considerations;
c. Drying the hygroscopic material, when possible and needed for future operation;
d. Adding moisture to the hygroscopic material, likewise when possible and needed for future operations.

The system may be built such that it can direct the air outgoing from the absorption element to the input for the heat exchanger, or to the surroundings, in the case that regeneration is needed and the air outgoing from the absorption element would decrease the heat pump performance. The addition of section 2 can be used in this embodiment, including the control system and multi-chamber system. The hygroscopic element may be liquid or solid, or a combination thereof. It is possible to construct a hybrid system which includes an integrated unit having three possible elements:
a. Regular compressor;
b. An evaporative cooling/absorptive heating unit;
c. A combination of these two

### 7. Improving the Indoor Air Conditioning Unit

An indoor air conditioning unit dries the air. This action, that is sometime not beneficial in terms of comfort is responsible for a significant part of the energy consumption. Adding a “desiccant wheel” that exchanges humidity between the air that enters ‘the indoor air conditioning unit’ with the air that leaves ‘the indoor air conditioning unit’, can save some of this energy and improve indoor humidity control.

A brief explanation for cooling: the ‘indoor unit’ coil gets to low temperatures that can cause air humidity to condense. If we will dry the incoming air we can prevent some or all this condensation. In order to dry this air we can use a desiccant material. After humidity absorption this desiccant can be regenerated by the air that leaves the ‘indoor unit’. For that the desiccant needs to be more temperature dependent than humidity depended. The desiccant can rotate between the incoming air and outgoing air.

A controller can determine if, when and how to activate this mechanism, in order to bring indoor humidity to the desired conditions.

The controller can also utilize low cost tariffs available (e.g. at night) for energy storage. Also external water may be added in some conditions.

### 8. Air Quality, Temperature, Humidity and Comfort Zone Center

All the above embodiments can have one or more inhumation sources as: an environmental data source, published data, a plurality of sensors, and a user interface; adapted to obtain at least one or more information of interest as: inside and outside air quality, thermal comfort, air temperature, humidity levels, surface radiation temperature, cloud cover, wind speed, wind direction, time in the day, time of the year, season, outdoor weather, daylight levels, light level solar index, solar angle, bad odor, carbon dioxide levels, carbon monoxide levels, oxygen levels, volatile organic compounds levels, radon level, particles detection, acrolein detection, dust, ozone, NOx, SOx, agricultural chemical, allergy triggers, heating gas leaks, smoke, pollen count, body temperature, body pulse, body dimension, dryness sensation, allergy reaction, breathing difficulties, sick or healthy state, body count, activity level activity schedules, habitation schedules, vacation schedules, clothing level, metabolism state, electricity tariff, fuels price, energy consumption, and forecasts future of the aforementioned information sources;

All the embodiment above can have the possibility to present this information and to advise for different action or even perform some actions such as: using a first state wherein air source is the outside air or a second state wherein air source is the inside air, increasing or decreasing ventilation, operating different filter, operating electric shutter, operating the above means for humidified, dehumidified heating or cooling the air or to give an advice for opening a window, vent, shutter or operating all of the above.

This center can can help save energy and improve air quality.

one basic system can contain an air quality sensor set that sense ether the outside air quality or the inside air quality or both. and wherein the controller operate the system in order to bring the inside conditions to the best possible, a non limiting example if there are poor air quality conditions in outside air (as in forest fire or in the rush traffic hours) the system will use the indoor air as the source of air. another non limiting example will be of using air source as the outside air is if there indoor air quality is poor as: level of CO2 is to high or bad odor or even gas leaks or smoke.

### 9. Desert Cooler/Improved Desert Cooler

Upon evaporation from liquid to gaseous state, water (and most materials) will cool their surroundings. A common device that uses this phenomenon is the desert cooler, which uses water that is periodically replenished to allow continued operation of the cooler.

The novelty we introduce allows for two new possibilities: operation of a desert cooler continuously without the necessity of addition of water; and operation of the device ‘in reverse’ to generate heat.

This is possible by introduction of two novelties: 1) ‘harvesting’ moisture due to natural fluctuations in the ambient humidity; and 2) running moist air over a dry hygroscopic material for heating, effectively reversing the normal operation of the desert cooler.

There are salts which are so highly hygroscopic that they will actually form liquid solutions if left in normal conditions of humidity and temperature. For example calcium chloride is a common salt used for melting ice on roads, which will deliquesce in many circumstances.

A solution containing such a salt will tend towards equilibrium with the room humidity; during the day if the humidity is low and the solution is dilute, water will evaporate from the solution to the air. When the humidity rises, such as at night the solution may absorb water, especially if it has during the day lost water and become more concentrated.

A few guidelines and definitions for operation of the inventive system are listed below.
a. After releasing moisture for cooling or absorbing it for heating, the hygroscopic material will generally need to be restored to its original condition. More particularly, good conditions for restoring the solution (or absorbent material, if a solid instead of liquid-desiccant is used) are ideally determined by consideration of the ‘next expected requirement’ (ie what operation will next be needed—humidification or dehumidification):
   i. When the saturation level is low and the next expected need is for cooling (by humidification) then adding water or absorbing water from the air will restore the solution conditions, to fulfill the upcoming requirements for humidification.
   ii. When the saturation level is high and the next expected need is for heating (by dehumidification) then evaporating water from the absorbent will restore the solution conditions.
b. Means for heat and mass exchange between the absorbent material (be it liquid or solid) and the air include:
   i. Blowing air through the absorbent material.
ii. Spraying the absorbent solution into the air
iii. Dripping the absorbent solution on a surface, vertically or horizontally or in a slope like on a roof.
   iv. Dripping the absorbent solution into its reservoir.
v. Pumping air into the solution.
vi. Using well known desert cooler mechanisms (e.g. dripping the solution over water-absorbent fabric strips, and blowing air through these strips).
c. Surface for liquid flow—this surface may be any surface with large area allowing liquid flow over the surface, having air (ideally an airflow) in contact with the liquid surface. The airflow may for instance be perpendicular to the fluid flow as in many desert coolers. Other methods for fluid flow may be used for instance running fluid over the sides or roof of a building. This method combines hygroscopic material and the building surface, allowing heating and cooling without addition of water.
d. Highly hygroscopic material—this is any material able to absorb an amount of water that is at least a few percent of its mass.
e. Air from the surroundings—this air may be either from within or without a dwelling
f. Liquid desiccant—liquid having a high hygroscopic nature such as calcium chloride in water.

### 10. Filter For Drying and Stabilization of Temperature and Humidity

The system can be used as a filter for particle trapping which also stabilizes temperature and humidity. A flat sheet or bed of woody material, vegetable fiber, or other suitable material as will be clear to one skilled in the art may be impregnated with highly hygroscopic material (or used alone of itself if it has a sufficiently hygroscopic nature). Forcing air through this device will stabilize the temperature and humidity in addition to cleaning the air. This example may be used for:
1. Air circulation from within the room to within the room
2. Air circulation of humid air from outside the room to inside the room
3. If the filter is such that the air source may be switched, further possibilities arise. A controlled version may use a controller with an algorithm as above.
4. A fourth version further allows switching both the input and output for the air, allowing outgoing air to be routed either within or without the room or building.

The novelty here is a device that is simple which passively cleans the air but also stabilizes temperature and humidity.

The filter can be implemented in creative ways as acoustic element or like a triangle covering the wall and the ceiling corner or even acoustic tiles.

FIG. 7 illustrates a case for a meeting room or classroom which can stabilize the incoming air humidity, clean the air, and to some degree stabilize the temperature by passing through activated acoustic tiles.

### 11. Greenhouses (Can be Implemented in Dwellings, Hangers, Sheds, Warehouse as Well)

The system may be employed in greenhouses or other buildings like hangers, sheds, warehouse, to cool, heat, humidify, or dehumidify. This process may be accomplished by use of a common evaporative cooling system in conjunction with the inventive method, which can improve the temperature and humidity conditions as made possible by external conditions. The ‘greenhouse cooling pad’ may be employed, for example by impregnating this large pad with hygroscopic material (FIG. 9 show this kind of pads after impregnating with a calcium chloride solution, used as scaling). Furthermore, the possibility of drying or humidifying the air may have a significant advantage in greenhouses.

Different option to perform the above include:
1. Replacing the water of an evaporative cooling solution with hygroscopic solutions, thereby stabilizing the temperature and humidity of the incoming air.
2. Impregnating the cooling pad with absorbent material or entirely changing the pad to sorbent material, with airflow channels; without the need for pumping water or solution, thereby stabilizing the temperature and humidity of the incoming air.
3. For all the above, having the possibility to add water when it is needed for example in dry or hot days or when more humid conditions are required.
4 For option 1 having a second cooling pad (or other means for heat and mass transfer with the air) that can evaporate or absorb water from or to the solution without changing the air inside the greenhouse; this can be done in time when restoring the solution conditions, changes the air conditions into conditions that are not the preferred ones. So restoring doesn't have a negative impact.
5. Option 4 that is using solar energy for drying the solution in the said second cooling pad.
6. Option 1 when the air, outgoing from the cooling, pad can be switch between being directed into the greenhouse (or dwellings) or back to the environment; this can be done in time when restoring the solution conditions, changes the air conditions into conditions that are not the preferred ones. So restoring doesn't have a negative impact.
7. Means for reversing the airflow, so the air goes from the greenhouse into the cooling pad, give the option for two air source for restoring the solution condition.
8. Adding to the above option sensors for: adsorbent saturation level, indoor and outdoor humidity, temperature allowing for estimating what will be the preferable operation.
9. Adding to the above option a controller associated with the different sensors, operation means and data for the desired greenhouse conditions; the controller is configured for bringing temperature and humidity conditions as close as possible to the desired one.
10. Option 9 where the controller is further associated with forecast data, historical data or other estimates of the coming day humidity and temperature, thereby optimize the next operation according to the coming days; for example harvesting water from the air, if the saturation level is low and the the coming days are expected to be dry.
11. Another possibility is by having at least two means for heat and mass exchange between the absorbent solution, at least on is indoor and the other is outdoor and the solution can move between them as needed, so no air exchange is not obligated.

All the above can be perforated for dwellings or other needs beside greenhouses.

### 12. Smart Envelope

The invention may in some embodiments comprise a ‘smart envelope’. The smart envelope involves means for heating, cooling and changing the wall's or envelope (or a section of wall's or envelop) permeability, allowing greater or lesser communication between the wall and the outside air. This may be accomplished by use of blowers, fans, electric blinds, electric curtains, electric windows, and vents. The wall has a large surface area and may be used to heat or cool the interior space by conduction/radiation. This method can also use an indirect heating and cooling where in modified air can go through an internal air gap. that has an advantage over the direct use of air being blown through the sorption material insofar as the humidity of the inside air is not affected. Thus for instance the air inside the wall may be brought to 100% humidity in order to cool it to the maximum extent possible (the dew point), and even though this extremely humid air would be uncomfortable inside the building, this is not problematic since this air is used only to cool the wall and is not conducted into the building; the cooled wall then cools the air within the building by conduction or radiation.

Blowing air through the air gap can also be used for storing cold or hot condition in the thermal mass to the envelope, in that case suitable outdoor air conditions can cool or heat the thermal mass without passing through the sorption material.

### 13. Photovoltaic and Electronic Cooling:

There is a negative correlation between photovoltaic cell power and cell temperature. Thus when PV modules are cooled they will give more power. One non limiting embodiment of the invention adapted for cooling PV cells comprises moisture absorption units that are attached to the back of PV panels, which evaporate moisture thereby cooling during the hot day day, and harvest water during the cooler and more humid night, to be used in the following day. Similarly, an absorption coating on the back of the panel can be used for this purpose.

There are many possible ways to implement an adsorption solution. For example one may use a mixture of an absorption solution like calcium chloride with a structural matrix holding the solution like bentonite, paper fiber, mixture of them or other. It is also possible to use aluminum matrix for holding the mixture and for heat transfer. CPUs and other electronics that need cooling may can use this method for cooling or for overcoming peaks in thermal loads. One non limiting example could be an absorption coating on the heat sink fins, this coating can evaporate humidity and cool down the heat sink when it is unusually hot, and restore water for further evaporation when the heat sink is colder.

### Simulation Tool

In solar power and wind power installations, we usually want to know the estimated yearly performance according to wind and solar resources available at a specific location. This Innovative energy source (using humidity fluctuations) similarly benefits from a simulation tool to estimate the yearly performance according to specific humidity fluctuations, such a simulation tool calculates the system performance according to humidity and temperature data for specific location during a specific time period. The simulation tool calculates the temperature and humidity of the air after it passes the system and calculates the sorbent material water saturation conditions in order to calculate, for the next moment, system performance.

it is possible to change location, amount of material, different speed for activation, and regeneration, and material type.

The simulation tool can predict the system performance and estimate the best action to take after calculating several options. It can also use data gleaned from its history in order to calibrate itself and predict other parameters like the building thermal mass, and operate the system to maximize these effects as well.

A learning algorithm can improve performance over time, by learning the thermal building behavior and the user's preference.

The simulation calculates the degree hours according to the desired comfort temperature, but it could also take into account the influence of humidity on the comfort feeling. In this way a dual strategy for achieving comfort zone is implemented—using temperature control, humidity control, or a combination of both.

This is a novel approach insofar as we provide one mechanism that can control both temperature and humidity in order to achieve comfort zone, rather then just achieving comfort temperature as in a normal air conditioner. Furthermore the inventive approach offers 4 different action at in one simple mechanism: cooling, heating, dehumidification and humidification.

The system can “move” into regeneration mode during specific times, for example when there is no one in an office or residence, thereby maximizing performance. It could also manage “Multi-reservoir systems” as described above.

### Smart Home Features

It is possible to add, to all the mentioned embodiment, means for communicating with a network connected device such as a computer, smartphone, or tablet in order to send and receive information from an environmental data source, providing (for instance) meteorological data from external services. This data may comprise such parameters as inside and outside air quality, thermal comfort, air temperature, humidity levels, surface radiation temperature, cloud cover, wind speed, wind direction, time in the day, time of the year, season, outdoor weather, daylight levels, light level solar index, solar angle, bad odor, carbon dioxide levels, carbon monoxide levels, oxygen levels, volatile organic compounds levels, radon level, particles detection, acrolein detection, dust, ozone, NOx, SOx, agricultural chemical, allergy triggers, heating gas leaks, smoke, air quality or pollution, pollen count, body temperature, body pulse, body dimension, dryness sensation, allergy reaction, breathing difficulties, sick or heathy state, body count, activity level, activity schedules, habitation schedules, vacation schedules, clothing level, metabolism state, electricity tariff, fuels price, energy consumption, and forecasts of future values of any of the aforementioned information sources. Further information may include logs of user behavior and preferences, published historical data, usage of other users in similar climates or locations, and the like. Site-specific building data may also be found useful, allowing use of a site's specific characteristics such as physical size and layout, thermal mass, shading, insulation, orientation, location, building envelope section, window locations, window direction, and energy consumption. Together these data, which may be gathered from multiple sources, allow the system to operate as an active air quality, temperature and humidity center by rebroadcasting and/or aggregating this data.

The device may further comprise a user interface adapted to display and obtain information of interest such as those mentioned above, and user preferences such as desired temperature and humidity.

The invention further comprises an algorithm using a set of rules for operating the valves and fans of the system. Generally speaking, the algorithm attempts to do two things: 1. bring the interior conditions as close as possible to the desired conditions; and 2. bring the sorption material to conditions that will allow for better fulfillment of the desired conditions in the future. Thus for example, at midday in summer, when cooling is desired and the sorption material is moist, air may be brought from outside, through the material thus cooling the air, and into the building. For replacement of the humidity that is lost from the material to the air during the day (aka regeneration) air may be cycled from outside the building, through the material, and back outside the building in the early morning hours (e.g. 2 am-5 am) when the outside air is highly humid.

As another example, in the case where heating is desired, and the sorption material is dry, outside air may again be forced through the sorption material, which will absorb humidity from the air (as long as the air is more humid than the sorption material). This may be done for instance in evening hours when the temperature drops and heating is desired, and the humidity levels of the outside air rise. In order to re-dry the air, relatively dry air of mid-day may be forced through the sorption material.

The algorithm uses known properties of the sorption material and its ‘humidity’ (the ‘humidity’ of the sorption material being simply the humidity of air in equilibrium with the sorption material) as well as projected future requirements and forecasts of future temperature and humidity, to reach decisions as to whether to dry or humidify the material, or to heat or cool the interior of the building. The properties of the sorption material (for example, the diffusion time, thermal mass, and hygroscopic behavior)

Information useful to the algorithm may be derived from sources such as fixed data sets, user interface inputs, user behavior data; and target ranges of combined comfort conditions.

The controller of the system is adapted to use this algorithm to bring the inside conditions closer to the target range of combined comfort conditions at the present moment and prepare the sorption material for the future. As mentioned briefly above, this is done (in a simple embodiment) by opening one or more of the vents and operating one or more fans, in order to do one of six things:
a. Blow air from outside the building through the hygroscopic material, and back outside the building, having the effect of drying or moistening the hygroscopic material, such that it is in condition for use later to heat/cool/moisten/dry incoming air;
b. Blow air from inside the building through the hygroscopic material and back into the building, having the effect of either heating and drying, or cooling and humidifying the air inside the building;
c. Blow air from outside the building, through the hygroscopic material, and into the building, having the effect of either heating and drying or cooling and humidifying the outside air that is passed into the building;
d. Blow air from inside the building, through the hygroscopic material, to outside the building, having the effect of either heating and drying the hygroscopic material or cooling and humidifying it;
e. Conduct air from outside the building, into the building without flowing through the sorption material; this implements what is termed ‘free cooling’ or ‘free heating’—if the outside air is hotter than the inside air, and heating is desired then the sorption material need not be used, and outside air may be simply passed inside. Similarly, if the outside air is cooler than the inside air and cooling is desired, then the same ‘pass through’ mode can be used.
f. Conduct air from inside the building to the outside, without flowing through the sorption material. This may be useful to exhaust stale or malodorous air for instance.

Rules may be used that allow for more important factors to take precedence over less important factors. For instance if extreme pollution or a fire has occurred outside, then conducting this air to the inside may be undesirable; in such a case, inside air may be passed through the sorption material and back into the inside of the building, if this bring the inside air closer to the desired conditions. Alternatively, the outside air may be conducting into the building but only at a slow rate, that allows the sorption material or filter material such as activated carbon that is in contact with the sorption material, to absorb any pollutants or odors from the outside air before passing this air to the inside. Humid air, for instance being released by an occupant taking a shower, may be used to humidify the sorption material and/or the air inside the building.

The algorithm mentioned above may use
i) heuristic methods;
ii) feedback models where the user is part of a control loop;
iii) mathematical or statistical methods which extract patterns from a plurality of data points;
iv) inference algorithms adapted to derive parameters from recorded data;
v) physical, physiological or psychological models;
vi) machine learning methods whereby user inputs, desired state of temperature and humidity, and actual state of temperature and humidity, are used to real force or weaken system decisions at any given state

The algorithm of the invention is configured to operate the different modes and states of the device to bring the inside conditions closer to the target range of combined comfort conditions at a given moment, and prepare the sorption reservoir for future use.
A user's personal comfort profile may be ‘mobile’ in the sense that it may be sent to different locations. For example a homeowner may allow his or her profile to be sent to a vacation house, such that his or her own comfort profile will be used at the vacation house when the user is there. Likewise, one's personal profile may be used at the workplace, restaurants, and the like. It is within provision of the invention to take into account the number of people inside the room or building to be conditioned. When several people profiles must be taken into account, an average can be calculated to approximate the desired ranges of each user, this way it is possible to use also the wisdom of the crowd.

Target ranges of combined comfort conditions may be refined by recording a user's behavior (e.g. the temperature humidity setpoints he/she has used in the past).

External devices may be incorporated and controlled by the system of the invention. For example, heaters, coolers, air conditioners, dehumidifiers, humidifiers, fresh air units, electric blinds, electric curtains, vents, lights, fans, blower, filters, purifiers, oxygen generators, heat storage, boilers, fridge, membrane, ionizers may be used to augment the operation of the device.

These external devices may allow the system to reach final levels of temperature and humidity that might not otherwise be possible; for instance if the sorption material can lower the temperature of incoming air by 5 degrees C., the desired temperature maximum is 20 degrees C., but the external air temperature is 30 degrees C., the incoming air may be cooled by the 5 degrees the sorption material can provide, and an external air conditioning unit may be used to provide the final 5 degrees of cooling to reach 20 degrees.

Data on these external devices' energy consumption, and their effect on the target ranges of combined conditions, may be obtained from one or more sources as:
vii) manufacturer data, literature, academic studies;
viii) data collected and analyzed from actual operating results and energy consumption measurements for a specific device on specific conditions;

The algorithm may be used to optimize some compromise between reaching desired ranges of temperature and humidity, and minimizing energy consumption or energy cost.

### Smart Air Flow;

The system may be used with several units as described above, installed at different sites of the building. These may be used in tandem, for example when pollution or unwanted odors are detected. To estimate the location of the pollution or odor, the algorithm may for instance compare the levels of said pollution as measured in the different systems. Once the location or source is identified, the controller may force air into and out of the various units in order to clear the pollution or smell using the shortest possible path.

Another use for several units, is to allow for one unit to regenerate, while the other unit provides air that is closer to the desired comfort zone.

The foregoing description and illustrations of the embodiments of the invention has been presented for the purposes of illustration. It is not intended to be exhaustive or to limit the invention to the above description in any form. The reference numbers in the claims are not a part of the claims, but rather used for facilitating the reading thereof. These reference numbers should not be interpreted as limiting the claims in any form.

What is claimed is:

1) A system for evaporative cooling and/or humidity balancing in a volume to be controlled, the system adapted to harvest its cooling water from its surrounding air when humidity is high, for further evaporative cooling when humidity is low, the system comprising:
(a) one or more sorbent reservoir containing a quantity of a sorption material in solid or liquid form;
(b) an arrangement of air paths providing fluid communication between at least one air inlet, said sorption material and exactly one air outlet;
(c) a flow control system comprising at least one fan associated with said air paths and deployed to selectively generate air flow for heat and mass exchange between said sorption material and said air flow;
(d) a saturation sensor set including at least one saturation sensor for obtaining a water saturation level of said sorption material that can be expressed as a relative humidity of air that is in equilibrium with said sorption material;
(e) a first relative humidity sensor set including at least one humidity sensor for obtaining relative humidity information of air entering said air inlet;
(f) a first temperature sensor set including at least one temperature sensor for determining a temperature in the volume to be controlled;
(g) a controller comprising at least one processor associated with said saturation sensor set, said first relative humidity sensor set and said first temperature sensor set, said controller being operatively connected to said flow control system so as to operate in a cooling mode by selectively switching said flow control system between the following operations:
(i) a cooling operation and/or air humidification operation wherein said controller operates said flow control system to cause heat and mass exchange between said sorption material and said air flow, when cooling is needed and when said air inlet relative humidity is lower than said relative humidity of air that is in equilibrium with said sorption material;
(ii) a water harvesting operation and/or air dehumidification operation wherein said controller operates said flow control system to cause heat and mass exchange between said sorption material and said air flow, when said air inlet relative humidity is higher than said relative humidity of air that is in equilibrium with said sorption material; and
(iii) a waiting state in which said flow control system does not cause heat and mass exchange with the sorption material when cooling is not required and when said air inlet relative humidity is not higher than said relative humidity of air that is in equilibrium with said sorption material,
thereby harnessing energy from relative humidity fluctuations for cooling, humidification and/or dehumidification, without requiring an external water supply or external energy sources other than energy needed for said flow control system and said controller.

2) The system of claim 1, wherein said controller is further operative in a heating mode by selectively switching said flow control system between the following operations:
i) a heating operation and/or air dehumidification operation wherein said controller operates said flow control system to cause heat and mass exchange between said sorption material and said air flow, when heating is needed and when said air inlet relative humidity is higher than said relative humidity of air that is in equilibrium with said sorption material
ii) a sorption material drying operation and/or air humidification operation wherein said controller operates said flow control system to cause heat and mass exchange between said sorption material and said air flow, when said air inlet relative humidity is lower than said relative humidity of air that is in equilibrium with said sorption material;
iii) a waiting state in which said flow control system does not cause heat and mass exchange with said sorption material when heating is not required and when said air inlet relative humidity is not lower than said relative humidity of air that is in equilibrium with said sorption material,
thereby harnessing energy from relative humidity fluctuation for cooling, heating, humidification and/or dehumidification.

3) The system of claim 2, deployed for conditioning an environment within an enclosure, wherein said air outlet is deployed for delivering air into said enclosure, and wherein said at least one air inlet is implemented as a first air inlet for drawing air from outside the enclosure and a second air inlet for drawing air from within the enclosure, said flow control system further comprising a switching arrangement including at least one switchable flow valve defining the following states:
a) a first state defining an air path from said first air inlet through said sorption material to said air outlet; and
b) a second state defining an air path from said second air inlet through said sorption material to said air outlet;
said controller being configured to switch said flow control system between said first and second states according to a relative humidity and temperature of air conditions inside and outside the enclosure.

4) The system of claim 2 or claim 3 wherein said air paths has a direct air path from said air inlet to said air outlet without passing through said sorption material and said flow control system further defining a third state in which said air flow flows through said direct air path, wherein said controller is further configured to switch said flow control system between the states according to a control modality that takes into consideration target values for humidity, air temperature, surface radiation temperature, thermal mass storage, free cooling, free heating and for regenerating the system for further operation.

5) The system of any one of claims 2-4, further comprising an air quality sensor set including at least one sensor configured to sense a parameter indicative of air quality, and wherein said controller is further responsive to an output of said air quality sensor set to switch said flow control system between the first and second states in a manner additionally dependent on the output of said air quality sensor set.

6) The system of any one of claims 2-5, deployed for conditioning a space within an enclosure and said enclosure is at least partially enclosed by an envelope and said envelope having an internal air gap; and wherein said air path further provide fluid communication with said internal air gap, and said flow control system further comprising a switching arrangement including at least one switchable flow valve defining a further state wherein said air flow pass through said internal air gap, thereby modifying the temperature of said space by modifying its said envelope temperature.

7) The system of any one of claims 2-6 wherein said sorbent reservoir is integrated into the envelope of said enclosure, for example wherein said sorption material is inside said envelope and acts as active insulation, or as thermal mass, or is sprayed on the inner side of a roof.

8) One or more systems as in claim 2 or claim 5, wherein there is an enclosure to be conditioned that is at least partially sealed, and said controller further switches said flow control system to a heat and mass recovery state wherein:
a) there is only one said air inlet; and
b) said air inlet and said air outlet alternate the air source and sink as inside or outside said enclosure, at predefined intervals time; and
c) said interval time allows for both: heat and mass exchange of said inside air with said sorption material, and heat and mass exchange of said outside air with said sorption material; and
thereby said sorption material mediates heat and mass exchange of inside out going air with outside incoming air.

9) The system of any one of claims 2-8, further comprising:
a) one or more information sources selected from the group consisting of : an environmental data source, published data, a plurality of sensors, and a user interface; adapted to obtain one or more information of interest selected from the group consisting of: said inside and outside air quality, indoor surface radiation temperature, cloud cover, wind speed, wind direction, time in the day, time of the year, season, outdoor weather, daylight levels, light level solar index, solar angle, bad odor, carbon dioxide levels, carbon monoxide levels, oxygen levels, volatile organic compounds levels, radon level, particles detection, acrolein detection, dust, ozone, NOx, SOx, agricultural chemical, allergy triggers, heating gas leaks, smoke, pollen count, body temperature, body pulse ,body dimension, dryness sensation, allergy reaction, breathing difficulties, sick or healthy state, body count, activity level, activity schedules, habitation schedules, vacation schedules, clothing level, metabolism state, electricity tariff, fuels price, energy consumption, and forecasts future of the aforementioned information of interest and forecasts of temperature and humidity;
b) a set of rules obtained from one or more sources selected from the list consisting of: fixed data set, user interface inputs, user behavior pattern data; that define setpoints and at least one user or space target ranges of combined comfort conditions;
and wherein said controller is further configured to operate the different said modes, said operations and said states in order to bring said inside conditions closer to said target range of combined comfort conditions at the present moment and prepare said sorption reservoir or reservoirs for the forecasts future.

10) The system of claim 9 wherein said target ranges of combined comfort conditions are refined by means of:
a) at least one data server configured to extract and store one or more user's or space behavior pattern data, user actions, said interface inputs at different conditions of said information of interest, and data arriving from communicating with other systems and/or sources,
b) an analytics engine configured to analyze said data server information and developing a user's personal comfort profile for predicting users preferences at different conditions and time said analytics engine uses one or more of the following methods selected from the list consisting of:
i) heuristic methods;
ii) feedback models where the user is part of a control loop;
iii) mathematical or statistical methods which extract patterns from plurality of data points;
iv) inference algorithms deriving parameters from recorded data;
v) physical, physiological or psychological models which can be adapted to recorded data sets;
vi) machine learning methods whereby user inputs are used to reinforce or weaken system decisions at any given state;
and wherein said controller is further configured to operate the different said modes, said operations and said states in order to bring said inside conditions closer to said target range of combined comfort conditions at the present moment and prepare said sorption reservoir for the forecasts future; and wherein said controller operates said system according to one or more of said user's comfort profiles.

11) The system of any one of claims 9-10 further comprising:
a) means for controlling one or more external device consisting of the group of: heaters, coolers, air conditioners, dehumidifiers, humidifiers, fresh air units, electric blinds, electric curtains, vents, lights, fans, blower, filters, purifiers, oxygen generators, heat storage, boilers, fridge, membrane, ionization, electric fragrance;
b) data on said external devices energy consumption and their effect on said target range of combined conditions obtained from one or more sources as:
i) manufacturer data, literature, academic studies;
ii) calculation for a specific site using its specific characteristics as size, shade, insulation, orientation, location, building envelope section, windows locations, windows direction, shading, energy consumption, user schedule, user action, user preferences;
iii) data collected and analyzed from actual operating results and energy consumption measurements for a specific device on specific conditions;
wherein said controller is further configured to operate said external devices, said modes, said operations, said states, in order to reach said target range of combined conditions in a way that minimizes energy consumption or energy costs while still meeting said target range.

12) The system of any preceding claim, wherein said absorption reservoir is implemented as a plurality of reservoirs, each with its own saturation sensor, and wherein said controller selectively operates a specific reservoir according to the saturation level of each reservoir and current or predicted requirements for heating or cooling.

13) A plurality of systems as in any one of claims 5, 8, 9, installed on different sides of said enclosure, and when pollution is detected in said enclosure said controller:
a) estimate the location of said pollution by compares the level of said pollution as measured in the different said systems;
b) operating at least one of said systems for evacuating air from said enclosure, and others of said systems for inserting air into said enclosure, in a way that makes the shortest air route for clearing said pollution.

14) The system of any preceding claim, where said system is embedded in a device selected from the group consisting of:
a) a desert cooler with or without the addition of water or heat source;
b) a lamp or chandelier with or without the addition of water or heat source;
c) a cornice with or without the addition of water or heat source;
d) an indoor fountain with or without the addition of water or heat source;
e) a piece of furniture with or without the addition of water or heat source;
f) an acoustic element as: acoustic ceiling acoustic wall, acoustic wall element, acoustic office cubicle, or acoustic cornice, with or without the addition of water or heat source;
g) a smart envelope, wherein air leaving said sorption material heats or cools the envelope thereby heating and cooling the space within said envelope, with or without the addition of water or heat source;
h) a smart envelope, wherein air leaving said sorption material heats or cools the space, with or without the addition of water or heat source;
i) an air filter having the possibility of humidity and temperature stabilization;
j) a fresh air unit introducing humidity-modified and temperature-modified air into a structure;
k) at least one fresh air unit altering the air flow direction, thereby recovering heat and mass from the outgoing air and transferring it to the incoming air, by blowing said outgoing and said incoming air it through said sorption material in an alternating sequence;
l) a plurality of fresh air units alternating in an opposite manner, wherein at least one unit allows the air to go out while the other let it in, and then changing roles;
m) in a stove or beside a stove;
n) in a greenhouse.

15) The system of claim 1 used for cooling one or more devices or objects selected from the group comprising of: batteries, vehicle, engines, car, vehicle, vehicle roof, computers, data centers, electronic devices, heat pumps, solar panels, reactors, radiator, convector, cooling fins, spices and dwellings, wherein cooling is performed in one or more of the ways selected from the group comprising of:
a) said outlet air is selectively or continuously put in fluid communication with said device or objects;
b) said sorption material is selectively or continuously put in fluid communication with a heat exchanger of said device and pre-cooling said device's intake air when conditions allow it;
c) at least part of said devices or objects is coated with said sorption material, thereby facilitating direct heat exchange with said devices or objects;
d) said sorption material is a liquid-sorbent being circulated between an interior heat and/or mass exchanger and an exterior heat and mass exchanger;
e) said sorption material is a part of an envelope of said device or object;
f) said sorption material further comprises a water source and a pump and said controller operates said pump in order to increase said sorption material saturation level when cooling is needed and said surrounding air relative humidity is higher than said relative humidity of air that is in equilibrium with said sorption material
g) said sorption material exchanges heat and mass with said air at least partially by using humidity exchange membrane for heat and mass exchange.

16) A system for cooling and/or humidity balancing based on liquid-desiccant that harvests cooling water from surrounding air, the system comprising of:
a) one or more liquid-desiccant reservoir containing a quantity of a liquid desiccant;
b) one or more liquid-to-air heat and mass exchanger providing an interface for fluid communication between said liquid-desiccant and air from the surroundings;
c) a flow control system comprising at least one liquid pump, said flow control system deployed to deliver said liquid desiccant to the interface of said heat and mass exchanger for heat and mass exchange with air from the surroundings;
d) a saturation sensor set for determining information on said liquid-desiccant saturation level that can be expressed as the relative humidity of air that is in equilibrium with said liquid-desiccant;
e) a first relative humidity sensor set for obtaining relative humidity information of said air from the surroundings;
f) a first temperature sensor set for determining if cooling is needed; and
g) a controller comprising at least one processor associated with said heat and mass exchanger, said flow control system, said saturation sensor set, said first relative humidity sensor set and said first temperature sensor set, said controller configured to selectively operate in a cooling mode by selectively switching said flow system and heat and mass exchanger between the following operations:
i) a cooling operation and/or air humidification operation wherein said controller operates said heat and mass exchanger for facilitating heat and mass exchange between said liquid-desiccant and said air inlet, when cooling is needed and when said surrounding air relative humidity is lower than said relative humidity of air that is in equilibrium with said liquid-desiccant;
ii) a water harvesting operation and/or air dehumidification operation wherein said controller operates said heat and mass exchanger for facilitating heat and mass exchange between said liquid-desiccant and said air inlet, when said surrounding air relative humidity is higher than said relative humidity of air in that is equilibrium with said liquid-desiccant;
iii) a waiting state wherein said controller does not operate said heat and mass exchanger, thus not facilitating heat and mass exchange between said liquid-desiccant and air from the surroundings;
thereby harnessing energy from relative humidity fluctuations for cooling, humidification, and dehumidification, without the necessity of using an external water supply or external energy sources other than energy needed for said flow control system and said controller.

17) The system of claim 16, further utilizing said first temperature sensor set for determining if heating is needed and said controller further configured to selectively switching said flow control system between the following operations:
a) a heating operation and/or air dehumidification operation wherein said controller operates said heat and mass exchanger for facilitating heat and/or mass exchange between said liquid-desiccant and said air inlet, when heating is needed and when said surrounding air relative humidity is higher than said relative humidity of air that is in equilibrium with said liquid-desiccant;
b) An sorption material drying operation and/or air humidification operation wherein said controller operates said heat and mass exchanger for facilitating heat and/or mass exchange between said liquid-desiccant and said air inlet, when said surrounding air relative humidity is lower than said relative humidity of air that is in equilibrium with said liquid-desiccant;
c) a storage operation wherein said controller does not operate said heat and mass exchanger, thus not facilitating heat and mass exchange between said liquid-desiccant and said air inlet, thereby storing the potential of cooling and/or heating and/or humidifying and/or dehumidifying.
thereby storing and utilizing the relative humidity fluctuation for cooling, heating, humidification and dehumidification, all that in one system comprising with few basic part and without the necessity of using external water heat source or other external energy source except for the minor energy needed for said flow control system and said controller.

18) The system in claim 17 wherein there is an enclosure to be conditioned that is at least partially or completely sealed, and said flow control system further comprising a blower arrangement including at least one fan and a switching arrangement including a plurality of switchable flow valves, and said air source and said air outlet can be in one or more states from the list comprising of the following:
a) side air source is the air outside said enclosure and said air outlet is the air inside said enclosure,
b) side air source is the air inside said enclosure, and said air outlet is the air outside said enclosure;
c) side air source is the air outside said enclosure, and said air outlet is the air outside said enclosure, or;
d) side air source is the air inside said enclosure, and said air outlet is the air inside said enclosure;
e) side air source is the air outside said enclosure, and said air outlet is a an internal air gap inside the envelope of said enclosure;
f) side air source is the air inside said enclosure, and said air outlet is an internal air gap inside the envelope of said enclosure.
wherein said controller is further configured to switch said flow control system between the states according to a control modality that takes into consideration target values for humidity, air temperature, envelope radiation temperature and/or air quality, thermal mass storage and for regenerating the system for further operation.

19) The system in claim 18 wherein said flow system comprising another state where air can pass through without exchanging heat and mass with said liquid-desiccant; wherein said controller is further configured to switch said flow control system between the states according to a control modality that takes into consideration target values for humidity, air temperature, envelope radiation temperature and/or air quality, thermal mass storage, free cooling, free heating, and for regenerating the system for further operation.

20) The system of any one of claims 17-19 that is used for environment controlled spaces, said system further comprising:
a) a second relative humidity sensor sensing the relative humidity in said environment controlled spaces;
b) data on target range of temperature and humidity inside said environment controlled spaces;
said flow control system further comprises, at least one pump, and a plurality of valves for connecting one or more said sorbent reservoir, to one or more said heat and mass exchanger, and circulating liquid-sorbent in one or more of the flow path form the list comprising of:
i) from one reservoir circulating to one heat and mass exchanger;
ii) from one heat and mass exchanger circulating to another heat and mass exchanger;
iii) from a specific reservoir of few reservoirs circulating to one heat and mass exchanger wherein using the the reservoir that its saturation level will bring the best performance according to the required mode and operation;
iv) to a specific heat and mass exchanger ether an indoor heat and mass exchanger or an outdoor heat and mass exchanger;
v) simultaneously circulating from one reservoir to one heat and mass exchanger and circulating from another reservoir to another heat and mass exchanger thereby having the possibility for performing different said mods at the same time;
wherein said controller is further configured to selectively assume said one or more of said flow path using one or more specific reservoir and heat and mass exchanger, so as to bring said environment controlled spaces towards said target temperature and humidity and said sorbent reservoir to their maximum further cooling and heating and humidity stabilizing potential.

21) One or more systems as in any one of claims 17-20, wherein there is an enclosure to be conditioned that is at least partially sealed, and said controller further switch said flow control system to a heat and mass recovery state wherein:
a) said air inlet and said air outlet alternate the air source and sink as inside or outside said enclosure, at predefined intervals; and
b) said interval time allows for both: heat and mass exchange of said inside air with said sorption material, and heat and mass exchange of said outside air with said sorption material; and
c) some of said systems are in said first state and others are in said second state, at alternate intervals.
thereby said sorption material mediate heat and mass exchange of said inside air with said outside.

22) The system of any one of claims 16-21 further comprising:
a) one or more information sources selected from the group consisting of: an environmental data source, published data, a plurality of sensors, and a user interface; adapted to obtain at least one or more information of interest selected from the group consisting of: said inside and outside air quality, thermal comfort, air temperature, humidity levels, surface radiation temperature, cloud cover, wind speed, wind direction, time in the day, time of the year, season, outdoor weather, daylight levels, light level solar index, solar angle, bad odor, carbon dioxide levels, carbon monoxide levels, oxygen levels, volatile organic compounds levels, radon level, particles detection, acrolein detection, dust, ozone, NOx, SOx, agricultural chemical, allergy triggers, heating gas leaks, smoke, pollen count, body temperature, body pulse, body dimension, dryness sensation, allergy reaction, breathing difficulties, sick or healthy state, body count, activity level, activity schedules, habitation schedules, vacation schedules, clothing level, metabolism state, electricity tariff, fuels price, energy consumption, and forecasts future of the aforementioned information sources;
b) a set of rules obtained from one or more sources selected from the list consisting of: fixed data set, user interface inputs, user behavior pattern data; that define setpoints and at least one user target ranges of combined comfort conditions;
and wherein said controller is further configured to operate the different said modes, operation and states in order to bring said inside conditions closer to said target range of combined comfort conditions at the present moment and prepare it for the forecasts future.

23) The system in claim 22 wherein said target ranges of combined comfort conditions are refined by means of:
a) at least one data server configured to extract and store one or more user's or space behavior pattern data, user actions, said interface inputs at different conditions of said information of interest, and data arriving from communicating with other systems and/or sources,
b) an analytics engine configured to analyze said data server information and developing a user's personal comfort profile for predicting users preferences at different conditions and time said analytics engine uses one or more of the following methods selected from the list consisting of:
i) heuristic methods;
ii) feedback models where the user is part of a control loop;
iii) mathematical or statistical methods which extract patterns from plurality of data points;
iv) inference algorithms deriving parameters from recorded data;
v) physical, physiological or psychological models which can be adapted to recorded data sets;
vi) machine learning methods whereby user inputs are used to reinforce or weaken system decisions at any given state;
and wherein said controller is further configured to operate the different said modes and states in order to bring said inside conditions closer to said target range of combined comfort conditions at the present moment and prepare it for the forecasts future, and wherein said controller operates said system according to one or more of said user's comfort profiles, thereby using the wisdom of the crowd.

24) The system of any one of claims 22-23 further comprising:
a) means for controlling one or more external device consisting of the group of: heaters, coolers, air conditioners, dehumidifiers, humidifiers, fresh air units, electric blinds, electric curtains, vents, lights, fans, blower, filters, purifiers, oxygen generators, heat storage, boilers, fridge, membrane, ionization;
b) data on said external devices energy consumption and their effect on said target range of combined conditions obtained from one or more sources as:
i) manufacturer data, literature, academic studies;
ii) calculation for a specific site using its specific characteristics as size, shade, insulation, orientation, location, building envelope section, windows locations, windows direction, shading, energy consumption, user schedule, user action, user preferences;
iii) data collected and analyzed from actual operating results and energy consumption measurements for a specific device on specific conditions;
wherein said controller is further configured to operate said external devices, said modes, said states, in order to reach said target range of combined conditions in a way that minimizes energy consumption or energy costs while still meeting said target range.

25) A plurality of any of system of claims 22-24, installed on different sides of said enclosure, and when pollution is detected in said enclosure said controller:
a) estimate the location of said pollution by compares the level of said pollution as measured in the different said systems;
b) operating at least one of said systems for evacuating air from said enclosure, and others of said systems for inserting air into said enclosure, in a way that makes the shortest air route for clearing said pollution.

26) The system of any one of claims 17-25 where said system is embedded in a device selected from the group consisting of:
a) a desert cooler;
b) a lamp or chandelier with or without the addition of water or heat source;
c) an active cornice with or without the addition of water or heat source;
d) an indoor fountain with or without the addition of water or heat source;
e) a piece of furniture with or without the addition of water or heat source;
f) an acoustic element as: acoustic ceiling acoustic wall, acoustic wall element, acoustic office cubicle, or acoustic cornice, with or without the addition of water or heat source;
g) a smart envelope, wherein air leaving said sorption material heats or cools the envelope thereby heating and cooling the space within said envelope, with or without the addition of water or heat source;
h) a smart envelope, wherein air leaving said sorption material heats or cools the space, with or without the addition of water or heat source;
i) an air filter having the possibility of humidity and temperature stabilization;
j) a fresh air unit introducing humidity-modified and temperature-modified air into a structure;
k) at least one fresh air unit altering the air flow direction, thereby recovering heat and mass from the outgoing air and transferring it to the incoming air, by blowing said outgoing and said incoming air it through said sorption material in an alternating sequence;
l) a plurality of fresh air units alternating in an opposite manner, wherein at least one unit allows the air to go out while the other let it in, and then changing roles;
m) in a stove or beside a stove;
n) in a greenhouse.

27) The system of claim 16 used for cooling at least one or more devices or objects selected from the group comprising of: batteries, cars, engines, car engine, cars roof, computers, data centers, electronic devices, heat pumps, HVAC system, solar panels, reactors, radiator, convector, cooling fins, spices, and dwellings, wherein said sorption material functions in one or more of the ways selected from the group comprising of:
a) said sorption material is selectively or continuously put in fluid communication with said device or objects, thereby pre-cooling said device's intake air when conditions allow it;
b) at least part of said devices or objects is coated with said sorption material, thereby facilitating direct heat exchange with said devices or objects;
c) said sorption material is a liquid-sorbent being circulated between an interior heat and/or mass exchanger and an exterior heat and mass exchanger;
d) said sorption material is a part of an envelope of a structure;
e) said sorption material further comprises a water source and a pump and said controller operates said pump in order to increase said sorption material saturation level when cooling is needed and said surrounding air relative humidity is higher than said relative humidity of air that is in equilibrium with said sorption material
f) said sorption material exchanges heat and mass with said air at least partially by using humidity exchange membrane for heat and mass exchange.

28) A method for evaporative cooling using cooling water harvested from at least one source of air, adapted to control the humidity and temperature of items selected from the list consisting of: a relocatable device, vessels, vehicle engine, vehicle roof, batteries, electric vehicle battery, energy storage device, cooling device, open spaces, computers, photovoltaic cells, solar panels, reactors, electronic devices, stove, water fountain; and comprising the steps of:
a) providing one or more sorbent reservoir containing a quantity of a sorption material in solid or liquid form;
b) monitoring the humidity of at least one of said source of air;
c) monitoring the saturation level of said sorption material, expressed as the relative humidity of air in equilibrium with said sorption material;
d) during a water harvesting period facilitating air transfer for heat and mass exchange between said sorption material and said source of air for harvesting said cooling water, when said source of air is more humid than said air that is in equilibrium with said sorption material, and interrupting said air transfer when said source of air is less humid than said air that is in equilibrium with said sorption material;
e) during a cooling period, facilitating air transfer for heat and mass exchange between said sorption material and said source of air for cooling when said source of air is dryer than said air that is in equilibrium with said sorption material, and interrupting said air transfer when said source of air is more humid than said air that is in equilibrium with said sorption material;
thereby using relative humidity fluctuations for cooling and/or humidification and/or dehumidification.

29) The method of claim 28 used for sorption heating wherein sorption material is dried by heat and mass exchange with at least one source of air, the method further comprising the steps of:
a) during a sorption material drying period, facilitating air transfer for heat and mass exchange between said sorption material and said source of air when said source of air is dryer than said air in equilibrium with said sorption material, and interrupting said air transfer when said source of air is more humid than said air that is in equilibrium with said sorption material;
b) during a heating period, facilitating air transfer for heat and mass exchange between said sorption material and said source of air for heating, when said source of air is more humid than said air that is in equilibrium with said sorption material, and interrupting said air transfer when said source of air is less humid than said air in equilibrium with said sorption material;
thereby using relative humidity fluctuations for cooling and/or heating and/or humidification, and/or dehumidification.

30) The method of claim 28 or claim 29, further used for humidification and/or dehumidification and further comprising the steps of:
a) facilitating heat and mass exchange between said sorption material and said source of air for harvesting water, when said source of air is more humid than said air that is in equilibrium with said sorption material;
b) facilitating heat and mass exchange between said sorption material and said source of air for humidification when said source of air is dryer than said air that is in equilibrium with said sorption material;
c) facilitating heat and/or mass exchange between said sorption material and said source of air for drying said sorption material, when said source of air is is dryer than said air that is in equilibrium with said sorption material;
d) facilitating heat and/or mass exchange between said sorption material and said source of air for dehumidification when said source of air is more humid than said air that is in equilibrium with said sorption material.

31) The method of claim 28 or claim 29 further used to control temperature and humidity of items selected from the list consisting of: desert coolers, fresh air units, heat exchanger, radiators, heat pump outdoor unit, radiator, convector, cooling fins, precooling and heating other cooling devices, water fountain, wall fountain, bubbles wall fountain.

32) The method of any one of claims 28-30 wherein facilitating heat and/or mass exchange occurs in one or more ways selected from the group consisting of:
a) using a constant air flow facilitating heat and mass exchange between said air flow and said sorbent material, thereby moderating daily or seasonal or yearly humidity and temperature fluctuations;
b) Using intermittent air flow when needed for different functions of cooling, heating, humidifying, dehumidifying, harvesting moisture, and drying said sorption material;
c) using an air flow alternating the source of said air back and forth between indoor and outdoor air, thereby allowing for heat and mass exchange between incoming air and outgoing air a non-limiting example is a fresh air unit with a heat and mass recovery.

33) The method of claims 28-30 wherein said air path is determined according to the following:
a) said source of air is either:
i) the outside air;
ii) said source of air is the inside air;
b) from said source, said air is directed to undergo heat and/or mass exchange with said sorption material, and then either:
i) into said item thereby heating and/or cooling and/or humidifying and/or dehumidifying said desired space;
ii) into the envelope of said item, thereby indirectly heating and/or cooling said desired space;
iii) outside said item, thereby harvesting cooling water or drying said sorption material without changing the air of desired space or object;
c) directing air to said item without a significant heat and mass exchange with said sorption material thereby allowing free cooling and/or free heating;

34) The method of claims 28-30 further estimating the humidity and temperature of outgoing air after heat and mass exchange with said sorption material by means of:
a) obtaining information about the relative humidity of air in equilibrium with said sorption material for different saturation level of said sorption material;
b) for a specific volume of air, calculating the difference in the amount of water absorbed in the incoming air, before and after reaching equilibrium with said sorption material;
c) calculating the amount of energy required for desorbing or absorbing said amount of water;
d) calculating the temperature change of said specific volume of air when said amount of energy is released into it or absorbed from it;
e) calculating said estimated temperature of said outgoing air by means of said temperature change;
f) calculating said estimated humidity of said outgoing air by means of said saturation level and an exchange rate coefficient.

35) The method of claim 30 or claim 33 or claim 34 further receiving at least one published coming forecast further estimate of environmental conditions selected from the list consisting of: temperature, humidity, solar index, cloud coverage, wind speed, and wind direction; estimating if a structure will require cooling or heating or humidification or dehumidification in the future, and further implementing one or more of the steps from the list consisting of:
a) harvesting water if a need for cooling or humidification is forecast and conditions allows it;
b) drying said sorption material if a need for heating or dehumidification is forecast and conditions allows it;
c) Implementing said free cooling if cooling is forecast to be needed in future and conditions allows it, by directing external air directly into said space or object and a significant bypassing said sorption material, thereby cooling and storing the low-temperature conditions in thermal mass;
d) Implementing free heating if heating is forecast to be needed in the future and conditions allows it, by directing air into said desired space or object bypassing said sorption material thereby cooling and storing the high-temperature conditions in thermal mass.

36) The method of claim 35 wherein said estimation of whether a structure will need cooling or heating or humidification or dehumidification is calculated using one or more of following sources of information:
a) construction data as materials, insulation level, windows, directions, siding;
b) energy consumption of electrical appliances used in said structure;
c) human activity in said structure;
d) type of clothes being worn in said structure;
e) the comfort zone of temperature and humidity defined for said structure and/or users;
f) a behavioral learning algorithm.

37) The method of claim 36 further comprising the following steps:
a) estimating and/or obtaining data of said air humidity and temperature after heat and mass exchange with said sorption material; and
b) choosing between said different functions, period and different said flow paths in order to reach the desired effect in both the present moment and in the future given the said estimation.

38) The method of claim 29 or claim 30 or claim 35 or claim 36 or claim 37 further comprising the following steps:
a) defining one or more comfort zones for one or more users or purposes, said comfort zone being defined for different times and conditions in terms of variables selected from the group consisting of: inside and outside air quality, thermal comfort, air temperature, humidity levels, surface radiation temperature, cloud cover, wind speed, wind direction, time of day, time of year, season, outdoor weather, daylight levels, light level, solar index, solar angle, presence of odors, CO2 levels, O2 levels, VOC levels, particle counts, NOx level, SOx level, presence of gas leaks, smoke levels, pollen count, body temperature, body pulse, body dimension, dryness sensation, allergy reaction, breathing difficulties, user state of health, room occupancy, activity level, clothing level, user metabolic rate, and energy consumption;
b) controlling one or more external devices selected from the group consisting of: heaters, air conditioners, dehumidifiers, humidifiers, fresh air units, electric blinds, electric curtains, vents, lights, fans, blower, filters, air purifiers, oxygen generators, heat storage, windows, water heaters, desert cooler, shade, refrigerators;
c) estimating the energy consumption of said external devices and their effect on said comfort zone;
d) choosing between said different functions, said flow ways, and said control of external devices in order to reach said comfort zone with a minimum of energy consumption or minimum energy cost as calculated based on the expected electricity tariff, for the present moment and for the future.

39) The method of claim 38 wherein said comfort zone is further redefined by a learning behavioral algorithm adapted to predict the preferences of one or more users at different time and conditions, said learning behavioral algorithm based on data selected from the list comprising of:
a) statistical data of aggregate user preferences in similar conditions;
b) historical records of said one or more users;
c) feedback models where the user is part of a control loop;
d) mathematical or statistical methods which extract patterns from plurality of data points;
e) inference algorithms deriving parameters from recorded data;
f) physical, physiological or psychological models which can be adapted to recorded data sets;
g) machine learning methods whereby user inputs and action are used to reinforce or weaken system decisions at any given state;
wherein said learning behavioral algorithm continues to use user feedback and actions to improve its prediction accuracy.

40) The method of claim 28 or claim 29 or claim 30 or claim 35 or claim 38 wherein said sorbent material is a liquid-sorbent, being heated, cooled, diluted or concentrated by surrounding conditions; and facilitating heat and mass exchange by ways selected from the group consisting of:
a) forcing a flow of said liquid-sorbent over surfaces selected from the group consisting of: interior walls, exterior walls, roof, thereby having the possibility for cooling or heating the building envelope, roof, and surfaces exposed to ambient air;
b) forcing ambient air into contact with said liquid-sorbent by means selected from the group consisting of:
i) forcing a flow of said liquid-sorbent over a surface and forcing a flow of air perpendicular or counter to the flow of said liquid-sorbent;
ii) forcing a flow of air through said liquid-sorbent;
iii) spraying said liquid into a body of air;
iv) spraying said liquid into an air flow;
v) using greenhouse pads for heat and mass exchange;
c) forcing a flow of air facilitating heat and mass exchange using a humidity exchange membrane;
d) forcing heat exchange, without mass exchange by means of a heat exchanger;
e) circulating said liquid-sorbent between an interior heat and/or mass exchanger and exterior heat and/or mass exchanger;
f) combining multiple heats and/or mass exchange units form one or more of the above, that operates on one or more reservoir of said liquid-sorbent.

41) The method of claim 29 wherein said relative humidity fluctuations are promoted by the use of a heat or humidity source selected from the group consisting of:
a) use of the relative humidity fluctuations promoted from fluctuations in heating a wood stove when it operates and cools, as dry air obtained from the output of said stove when said stove operates in the evening time, and humid air obtained from said stove early in the morning when the wood supply burns out, thereby balancing fluctuations of both humidity and temperature;
b) a storage heater using low tariff electricity for drying the air associated with said sorbent material and storing that energy for use at times when said electricity tariff is high, thereby storing energy by latent heat as in sensible heat, and balancing humidity fluctuation;
c) using solar energy for promoting (fortifying) the natural phenomenon of decreasing the relative humidity of said air as during sunny days or summer time and storing that energy for use in time where it is needed;
d) using waste heat for drying the air associated with said sorbent material and storing that energy for use in time where it is needed.
